(19) United States
(12) Patent Application Publication
(10) Pub. No.: US 2026/0081348 A1
(43) Pub. Date: Mar. 19, 2026

(54) ANTENNA DEVICE

(71) Applicant: HUBER-SUHNER AG, Herisau (CH)

(72) Inventors: Alejandro GARCIA TEJERO, St. Gallen (CH); Jan FEIKE, Stein (CH); Fernando RODRIGUEZ VARELA, Madrid (ES); Pietro ROMANO, Rorschach (CH); Eugen WILLMANN, Arbon (CH); Jerzy KOWALEWSKI, St.Gallen (CH); Francesco MERLI, Thal (CH)

(73) Assignee: HUBER-SUHNER AG, CH-9100 HERISAU (CH)

(21) Appl. No.: 19/108,063

(22) PCT Filed: Sep. 7, 2023
(86) PCT No.: PCT/EP2023/074543

§ 371 Date: Feb. 28, 2025

(30) Foreign Application Priority Data
Sep. 14, 2022 (CH) CH001070/2022

(51) Int. Cl. H01Q 1/32; H01Q 1/40; H01Q 21/00; H01Q 21/06

(52) U.S. Cl. CPC H01Q 1/3233; H01Q 1/405; H01Q 21/005; H01Q 21/0087; H01Q 21/064

(57) ABSTRACT

An antenna device for automotive radar applications includes a printed circuit board having a front face and a back face and an electronic component which is interconnected to the printed circuit board and an antenna layer having a front face and a back face, which back face is interconnected to the front face of the printed circuit board. At least one waveguide aperture is interconnected to the front face of the antenna layer and is communicatively connected to the electronic component by at least one waveguide channel, wherein the at least one waveguide channel comprises a conductive surface for guiding an electromagnetic field between the electronic component and is formed by a recess arranged between the back face of the antenna layer and the front face of the printed circuit board.

### BACKGROUND OF THE INVENTION

### Field of the Invention

The present disclosure relates to an antenna device, e.g. for use in automotive radar applications.

### Discussion of Related Art

WO 2022122319 A1 published on 16 Jun. 2022 in the name of the applicant relates to an antenna device comprising a printed circuit board and a thereon arranged electronic component. The antenna device comprises at least two individual antenna elements, which are interconnected to the electronic component configured to transmit and receive a signal. The antenna elements each comprise at least one waveguide channel interconnecting in the antenna assembly. A first waveguide aperture is arranged at a back face of the antenna assembly. Said first waveguide aperture is interconnected to the electronic component and configured to transmit and/or receive a signal. A second wave-guide aperture is arranged at a front face of the waveguide assembly and is also configured to transmit and/or receive a signal.

WO 2021163381 A1 published on 19 Aug. 2021 in the name of Veoneer US Inc. relates to radar sensor assemblies/modules, particularly those for vehicles, which comprise a plurality of waveguides. Each waveguide of the plurality of waveguides is defined by a waveguide groove. A slot may be positioned to ex-tend along an axis of each of the plurality of waveguide grooves. E ach of the waveguides may be further defined, at least in part, by a periodic feature that extends back and forth in a periodic manner along at least a portion of its respective waveguide and a plurality of periodic signal confinement structures, a first periodic signal confinement structure of which may extend adjacent to a first side of each of the plurality of waveguides, and a second periodic signal confinement structure which may extend along a second side of each of the plurality of waveguides opposite the first side.

WO 2022053114 A1 published on 17 Mar. 2022 in the name of Conti Temic Microelectronic GmbH relates to a radar system for detecting surroundings, having a printed circuit board, which has at least one high-frequency component with at least one directly emitting or receiving element, and a molded part, which has one or more individual antennas for transmitting and/or receiving radar signals on the molded part upper face, wherein the connection between the at least one emitting or receiving element of the high-frequency component and the at least one individual antenna on the upper face of the molded part is implemented at least partly by hollow inner waveguides. The emitting/receiving element of the high-frequency component emits in the direction of the printed circuit board, and the printed circuit board is permeable to radar waves in said region. The molded part is electrically connected to the printed circuit board by soldering and/or conductive adhesion. The printed circuit board feeds the waveguide from a permeable location of the printed circuit board, and the molded part consists of an at least partially metallized single-layer plastic part.

US20220196792 A1 published on 23 Jun. 2022 in the name of Robert Bosch GmbH relates to a method for manufacturing a radar sensor. In the method, a circuit board is provided. A surface of the circuit board is equipped with a radar transceiver. A waveguide structure made of plastic material is provided. Waveguide channels including at least one metallic conductively coated side wall in the waveguide structure and an open side are formed. The waveguide structure is soldered to a surface of the circuit board, the open side being oriented in the direction of the circuit board.

US20210249784 A1 published on 12 Aug. 2021 in the name of Veoneer US Inc. relates to antenna and/or waveguide assemblies for vehicles, such as radar sensor antenna assemblies, along with associated signal confinement structures. In some embodiments, the assembly may comprise an antenna block defining one or more waveguides. A conductive layer may be coupled to the antenna block to form, at least in part, a wall of the waveguide. The assembly may comprise one or more periodic structures that may be operably coupled to the waveguide, each of which may comprise a first elongated opening and a first series of repeated slots extending at least substantially transverse to the first elongated opening, wherein each of the first series of repeated slots is spaced apart from an adjacent slot in the first series of repeated slots along the first elongated opening.

### SUMMARY OF THE INVENTION

Antenna devices are e.g. in the automotive industry widely used components for communication devices and radar applications or form part of assisted or autonomous driving systems. For these applications, typically signals with millimeter-wave frequencies are used. Besides the antenna performance, like antenna gain and efficiency, which are all crucial parameters since they directly affect the overall system performance, also a mechanically simple set-up is desired, given the vast production numbers of these antenna devices.

Antenna devices can be designed as printed circuit board antennas (PCB antennas), which are normally used at lower frequencies, but can also be used at millimeter-wave frequencies. However, they typically come with a drawback in terms of performance. More specifically, PCB antennas usually comprise planar metallic structures as radiating elements. They are usually realized on top of or integrated in dielectric substrate layers. The connection of these radiating elements with a chip, respectively electronic components, foreseen for generating/receiving the power (signal) to be transmitted/received is realized through additional planar structures, namely transmission lines, such as e.g. microstrip, coplanar waveguide, stripline, which guide the signal from the chip to the radiating part. These antenna systems tend to be very lossy at millimeter-wave frequencies (especially for frequencies higher than 60 GHz) due to the particular dielectric properties of the substrate materials. These losses drastically reduce antenna efficiency/performance and, at the same time, increase the power that needs to be dissipated inside the systems.

As alternative to the PCB antennas, with the before mentioned drawbacks, air-filled waveguide antennas have been developed. Generic air-filled waveguides used at microwave and millimeter-waves are hollow conductive pipes that are able to guide the electromagnetic signal from point A to point B with negligible losses (depending on the metal conductivity). Standard millimeter-wave frequencies waveguide assemblies are typically manufactured using advanced machining techniques with very low tolerance requirements, like high-precision milling, micromachining, etc. However, these techniques show limitations since air-filled waveguide antennas typically require a complex power splitting/combination network that connects the antenna feeding point with the radiating structures. Both the radiating structures and the feeding network typically include specific features that require low tolerances (in the order of tens of micron).

An aspect of the disclosure is to address these manufacturing limitations/drawbacks, based on the considerable performance advantage of waveguide technology with respect, for instance, to printed circuit board (PCB).

In view of a cost effective production, one goal is to achieve designs and techniques to implement MIMO antenna arrays that can be manufactured using only a minimum number of stacked layers (parts). Given the above advantages of waveguide technology in terms of performance, and considering the tight tolerance requirements for manufacturing, an aspect of the disclosure is directed to a combination of innovative radio frequency and a mechanical design with advanced manufacturing to implement high-performance millimeter-wave frequency waveguide antennas and components, especially for automotive applications with up to only a single antenna layer.

An antenna device for automotive radar applications according to the present disclosure typically comprises a printed circuit board (PCB) having a front face and a back face and an electronic component which is interconnected to the printed circuit board. As electronic components, typically radar chips, like e.g. monolithic microwave integrated circuits (MMICs) are used, which comprise multiple circuits integrated into small packages for operation at microwave frequencies. These MMICs are typically directly arranged on the front face or the back face of the printed circuit board. Alternatively, the electronic component can be interconnected with the printed circuit board, respectively electronic components, foreseen for generating/receiving the power (signal) to be transmitted/received, through additional planar structures, namely transmission lines, such as e.g. microstrips, coplanar waveguides or striplines, which guide the signal from the chip to the radiating part.

For guiding the signals from the electronic component to at least one waveguide aperture, configured for transmitting and/or receiving the signal, the antenna device typically comprises an antenna layer. Good results regarding the signal transmission can be achieved, when the antenna layer has a front face and a back face, which back face is interconnected to the front face of the printed circuit board. In a variation, the antenna layer is in addition configured to function as radome, protecting at least the printed circuit board and/or components within the antenna device from environmental influences. Therefore, the antenna layer is at least partially made from a material, which is resistant to environmental influences, e.g. a material that does not absorb humidity. In a variation, the back face of the antenna layer is in direct contact with the front face of the printed circuit board (PCB) or a coating on the front face of the printed circuit board. The distance between the back face of the antenna layer and the front face of the PCB may be essentially zero or in the form of an air gap which is typically less than the length of the wavelength (A).

Alternatively, or in addition, the electronic component in the form of a chip (MMIC) may be embedded into the printed circuit board. The chip can thereby be embedded into one of the layers of the substrate material. Such substrate material typically consists of printed circuit board material or any other material (silicon, ceramic, glass, mold compound) suitable for embedding the chip.

The electromagnetic signal can be fed from the chip to the at least one waveguide channel inside the antenna layer by planar transition lines or by three-dimensional transition lines, which are in form of substrate integrated waveguides (SIW), dielectrically loaded embedded waveguides and/or air-filled embedded waveguides. This can be the case irrespective of whether the chip is embedded into the printed circuit board or mounted on the top or bottom of the printed circuit board.

In another variation, the back face of the antenna layer can be interconnected to the front face of the printed circuit board by at least one intermediate layer. In a variation, the intermediate layer can be in the form of a coating or an additional antenna layer. Between the front face of the PCB and the back face of the antenna layer, a plate shaped intermediate layer can be arranged. A front face of the intermediate layer may face the back face of the antenna layer. A back face of the intermediate layer may face the front face of the PCB. The waveguide apertures are typically interconnected to the front face of the antenna layer and communicatively connected to the electronic component by waveguide channels. The waveguide channels may at least partially be arranged within the intermediate layer, extending from the back face to the front face of the intermediate layer.

The intermediate layer can also comprise several part or layers, e.g. comprise at least one front layer and a thereto connected back layer. The intermediate layer may comprise a plate shaped front layer and a back layer. The back layer and the front layer are typically joined along a parting plane. The front face of the intermediate layer, facing the back face of the antenna layer, is in this variation arranged at the front layer. The back face of the intermediate layer, facing the front face of the PCB, is in this variation arranged at the back layer. A scattering surface, as described in more detail further down below in the description, can be implemented in the back face of the antenna layer and/or a back face of the intermediate layer and/or the back face of the front layer of the intermediate layer, in form of arrays of cavities next to the waveguide channels. The scattering surface is typically arranged in order to reduce or cancel reflections that occur where there is a change of media, which typically equals to a change of permittivity. The scattering surface can reduce or cancel reflections between the front face of the antenna layer and the back face of the antenna layer. Alternatively, or in addition, the scattering surface can reduce or cancel reflections between the back face of the antenna layer and an external component, e.g. a bumper in automotive applications, which is spaced a distance apart from the antenna device.

Good results can be achieved when the signal is fed from the electronic component, typically a radar chip in form of a MMIC into at least one waveguide channel. Good results can be achieved when the waveguide channel is designed as a tubular channel with one channel wall being formed by the front face of the PCB or the front face of an intermediate layer and the other channel walls being formed by a recess being arranged at or forming part of the back face of the antenna layer. Good results can be further achieved when the waveguide channel comprises at least a waveguide cross section out of the group of the following geometries or a combination thereof: Rectangle, rhomb, ellipse, trapezoidal, half-moon etc. The signal is typically fed via the at least one waveguide channel into at least one waveguide aperture. The at least one waveguide aperture can be designed as a slot or horn antenna which is integrated in, on or behind the front face of the antenna layer. In order to obtain a smooth wideband impedance transition from the waveguide channel through the antenna layer, a material for the antenna layer with a lower electrical permittivity (dk˜1-6) is preferred.

For receiving or transmitting a signal, at least one waveguide aperture is typically interconnected to the front face of the antenna layer and is communicatively connected to the electronic component by at least one waveguide channel. In a variation, the at least one waveguide channel is designed as a rectangular waveguide channel, which can be seen as a pipe consisting of typically four walls. The waveguide channel is typically formed by a recess arranged between the back face of the antenna layer and the front face of the printed circuit board. Good results regarding the manufacturing of the waveguide channel can be obtained if at least the walls of the recess are designed with draft angles. For being able to guide an electromagnetic signal, the at least one waveguide channel typically comprises a conductive surface for guiding the electromagnetic field between the electronic component and the at least one waveguide aperture. To be conductive, the antenna layer, which can also function as cover (radome), can be metallized on the backside in order to create a conductive surface. The waveguide channel can be formed by directly placing the recess in direct contact with the metallized front face of the PCB or a conductive intermediate layer between back face of the antenna layer and the PCB.

A particularly simple design can be achieved with the back face of the antenna layer being arranged on the front face of the printed circuit board and being back-up by a back layer or housing. The printed circuit board can be arranged between the antenna layer and the back layer or housing in a sandwich type structure. Good results can be achieved when the antenna layer and the back layer or housing form the overall housing of the antenna device, encompassing the PCB and protecting the internal components of the antenna device from environmental influences. For an easy and a positional accurate assembly, the antenna layer, PCB and back layer or housing can be assembled via connection elements protruding from the back face of the antenna layer. The connection elements can be designed as pins, which in the assembled state protrude though bores in the PCB and are received by receiving openings in the back layer or housing.

The main advantage of this design compared to known designs are lower costs, as there is no need of having antenna layer made of several individual layers. In addition, no additional separate radome is required. As the number of antenna layers is reduced compared to known designs, the thickness of the overall antenna device can be significantly reduced. Additionally, in known designs usually the radome is placed at a distance between 24 to 2 (1 mm-4 mm at 77 GHz) with respect to the PCB, this distance can be also removed. This makes the design e.g. suitable for small sensors, being used as corner, front, side or rear radars in automotive applications, where the cost is extremely important. The antenna layer does not have to be essentially flat. If appropriate, the antenna layer can be at least partially skeletonized to reduce the contact surface between the antenna layer and the printed circuit board. This is advantageous as a minimized contact area increases the surface pressure of the contact area and therefore results in a more accurate alignment of the antenna layer and the printed circuit board.

Highly accurate molding parting lines are desired to have minimum impact on the propagation of the electromagnetic signal (i.e., minimum losses and mismatching) once the antenna layer is interconnected with or directly arranged on the printed circuit board. The design of the waveguide channel and the antenna layer may be optimized to be compatible with a variety of joining techniques. In a variation, the front face of the printed circuit board and the back face of the antenna layer are essentially flat. This can be particularly advantageous as preferred joining techniques may include at least one out of the group of soldering, welding, gluing (both conductive and non-conductive), clamping or a combination thereof. In a variation the antenna layer can act as housing for the radar device, whereby the printed circuit board is sealed by means of a plate shaped back cover.

The antenna layer is typically at least partially made from a metallic material and/or comprises a metallization layer forming a conductive surface. In case that the antenna layer is made by injection molding of at least one plastic material, typically the back layer and/or the recess is metalized by an electrically conductive material. Alternatively, or in addition, the antenna layer can be made of metallized plastic and/or any other material conductive at the surface. Techniques such as high-precision plastic injection molding and, if required, metallization process can be used. For variations where an additional coating or metallization layer is desired, typical coating processes include the back face of the antenna layer being metallized by applying e.g. a physical vapor deposition (PVD) coating, flame spraying a coating, or an electro- or electroless plating, etc. Alternatively, or in addition, injection molding can be used whereby the conductivity of the antenna layer can be increased by using injection molding technology of any additional conductive part e.g. sheet metal or metallic film (film injection molding). Over molding, whereby the conductive material (plastic filled with conductive filler) can be over molded to another non-conductive plastic material can be applied as well. F or over molding, also called insertion molding, a metallic insert may be over molded by a molten plastic, which is injected into the mold, forming the antenna layer.

Good results regarding the manufacturability can be achieved when the recess is at least partially formed by a deepening in the back face of the antenna layer. This is particularly beneficial for injection molding or die-casting as the parts can be easily demolded. The recess may at least partially formed by a deepening in the back face of the antenna layer and/or protrusions. Alternatively, or in addition to the protrusions, intrusions can be arranged in the back face of the antenna layer. An EBG structure is formed by the protrusions extending above the back face of the antenna layer and/or a planar metallic structure on the front face of the printed circuit board. The protrusions can be made integrally with the antenna layer, laterally delimiting the recess and form an electromagnetic band-gap structure with the front face of the printed circuit board. Alternatively, or in addition, a planar metallic structure which comprises a number of patches can be arranged on the front face of the PCB, which patches laterally delimit the recess and form an electromagnetic band-gap structure with the protrusions or the back face of the antenna layer. The antenna layer may comprise a ridge, which is arranged within the recess and extends substantially along the waveguide channel. A ridge can be arranged within the recess of the waveguide channel for reducing the overall size of the waveguide channel. Alternatively, or in addition, the waveguide channels can be implemented in the form of a coaxial waveguide by including a metallic strip at the center of the waveguide channel for further size reduction.

Another aspect of the present disclosure is the use of artificial magnetic conductors (AMCs) in the context of antenna devices. AMCs are an approximation of perfect magnetic conductors (PMCs), which do only exist in theory, but can be approximated in a limited bandwidth by AMCs. AMCs can prevent the transmission of a magnetic field parallel to the materials surface. AMCs can be created by periodical or randomized patterns. On a PCB this can be implemented by periodically arranging metallic patches or in a fully metallic surface arranging periodic cavities (the complementary case to patches).

The underlying theory of AMCs is a perfect magnetic conductor (PMC), which is an idealized material, which does not allow propagation of magnetic field inside of it. In the context of antenna devices, the artificial magnetic conductor can fulfill two purposes. Arranging an AMC structure on the front face of the PCB, which in the mounted state faces the back face of the antenna layer, can form an electromagnetic band gap (EBG) structure between the AMC structure and the back face of the antenna layer. This EBG structure avoids an unwanted propagation of electromagnetic waves outside of the defined waveguide channel. Alternatively, or in addition, the parts of the AMC structure which in the mounted state can form together with the recess of the antenna layer a waveguide channel, can allow to decrease the height of the waveguide channel, therefore the height/depths of the recess in the antenna layer and thereby may decrease the overall height of the antenna device.

With an AMC structure arranged on the front face of the PCB, the waveguide channel can be designed as a half-mode waveguide. The underlying concept of a half-mode waveguide is to halve the height of the waveguide channel. To be able to halve the height and still be able to guide the signal, the concept is to mirror the E-field of the signal with the artificial magnetic conductor (AMC). The patches can be e.g. rectangular, circular or pentagonal, hexagonal, elongated, ellipsoidal in shape. The patched may be placed in a linear symmetrical, glide symmetrical or randomized pattern on the front face of the PCB. An alternative variation for creating an AMC is to arrange a fully metallic plane with polygonal apertures or protrusions, e.g. in form of cavities, on the back face of the antenna layer, instead of having metallic patches on the front face of the PCB.

The lateral distance between the patches with respect to each other, the periodicity, is typically chosen in relation to the emitted wavelength. The size of the patches is related to the guided wavelength. The wavelength can be calculated as follows:

$$λ = \frac{{λ}_{0}}{\sqrt{{ε}_{r P C B}}}$$

λ₀=free air wavelength
ε_{r PCB}=permittivity of the PCB substrate

The periodicity is usually chosen in a range between λ₀/8−2λ₀. The patches are typically arranged in collinear arrays, with the arrays forming rows and columns. Between neighboring columns the patches are spaced with a first periodicity Pₓ and between neighboring rows with a second periodicity P_{y}. As a result, in a top view on the front face of the PCB the patches can form a matrix. In addition, the arrays can be shifted with respect to each other. While the patches within one array are spaced with a distance equal to the periodicity, neighboring arrays can be shifted with respect to each other by a distance which equals to P/n with n being a natural number. This leads to a staggered design. A periodic pattern of patches has the advantages that even a misalignment of the antenna layer with respect to the printed circuit board, either a lateral displacement or angular displacement, does not impact the magnetic and electrical properties.

In typical automotive radar applications the free air wavelength do is in a range of mm-wave frequencies from 10 mm to 1 mm. In a specific variation with a frequency range of 55 GHz to 85 GHz the free air wavelength λ₀ is in a range of 5.5 mm to 3.5 mm. A typical value for the periodicity with the free air wavelength do in a range of 5.5 mm to 3.5 mm is approximately λ₀/3. Alternatively, or in addition, protrusions can be arranged on the back face of the antenna layer or the intermediate layer, forming an AMC structure. These protrusions can be in form of pillars extending from the back face of the antenna layer or intermediate layer towards the front face of the printed circuit board and may be combined with patches on the front face of the PCB.

The at least one waveguide aperture can be incorporated behind the front face of the antenna layer as penetration in the conductive surface. The penetration may be established by a material ablation process, preferably by a laser process and/or a cutting process. After manufacturing the antenna layer, the waveguide aperture, e.g. designed as slots and/or horns, which are needed for radiation can be realized in an etching process after previous metallization of the full surface of the waveguide channel and/or the back face of the antenna layer. In that case, the metallized surface will be removed by an etching technology. Alternatively, the waveguide apertures needed for radiation can be realized in a mechanical subtraction process e.g. by engraving, scratching, or milling, or by an ablation process, e.g. by a laser ablation process. By using the energy of a laser, the metallic surface can be removed. Alternatively, the slots can be realized during the coating process by using a mask.

To reduce the losses of the signal within the material during transmitting and or receiving the signal, the thickness of the material between the radiation slots and the front face of the antenna layer is preferably kept smaller than two times the wavelength to avoid propagation of electromagnetic waves in the material, if a directive radiation pattern is desired. For non-directive radiation pattern, a thicker material layer between front layer and antenna aperture is favorable. If the antenna layer is too thick, part of the energy is not able to excite the material of the antenna layer and creates a surface wave that reduce the efficiency of antenna and degrades the pattern. To reduce the losses, the antenna layer can be made by a foaming process. A foam may reduce the permittivity compared to a high density material without compromising on the thickness. The antenna layer can be made by an injection molding process made of a foamed material and comprise a sandwich structure and/or a cellular structure with a harder skin layer and a softer core. Foam injection molding is a manufacturing process, which can be used to lower the permittivity of the antenna layer and achieve the required properties for radiation through the antenna layer. Given the cellular core and the thin skin the permittivity of the material can be reduced compared to a traditional injection molding part.

Alternatively, or in addition, for transmitting and/or receiving a signal, the at least one waveguide aperture can be incorporated as a cavity in the back face of the antenna layer or behind the front face of the antenna layer. The cavity may at least partially filled by a material that is permeable for electromagnetic waves. The cavity can be filled with dielectric resonators, which constitute of a cube made of a material with higher dielectric constant than the surrounding antenna layer (e.g. radome material dk=2, dielectric resonator dk=5.5). The dielectric resonators are configured to increase the antenna gain. Rotated dielectric resonators can be used to change the radiated field polarization. An antenna layer with dielectric resonators can be realized by over molding, 2K molding, whereas the outer layer and dielectric resonators are made of one material and the core consists of the second material, or by foam injection molding, whereas dielectric resonators are part of the skin layer.

Depending on the design, the electronic component can be arranged at the back face of the printed circuit board communicatively connected to the at least one waveguide channel by a feeding aperture extending across the printed circuit board from the back face to the front face. An electronic component, like a MMIC can be coupled to the waveguide channel through at least one feeding aperture designed as a bore in the PCB. This bore is typically permeable for electromagnetic waves and can be plated and filled with material or it may comprise a ridge. Alternatively, the electronic component can be arranged at the front face of the printed circuit board being in the assembled state encompassed by a receiving space within the antenna layer and covered by an electromagnetic absorber, like in form of a layer. In a variation the MMIC component may be soldered on the top face of the PCB. Additionally, an electromagnetic absorber may be placed on the chip to reduce any electromagnetic interference from the waveguide channels or a heat sink structure may be placed for cooling the electronic component.

The front face of the antenna layer can be corrugated to further reduce the permittivity and implement a quarter-wavelength or broadband impedance transformation for the wave radiated from the waveguide apertures through the front surface. The corrugation allows removing material from the antenna layer, which can be replaced by air, thus reducing the overall permittivity of the antenna device. The waves radiated from the waveguide apertures propagates in a material with lower permittivity. As such, they undergo less distortion and the structure may achieve a more uniform radiation profile. The front face of the antenna layer can be designed as a corrugated surface comprising arrays of indentations for reducing the overall permittivity.

Alternatively, or in addition, a scattering surface can be arranged at the back face of the antenna layer adjacent to the at least one waveguide channel consisting of protrusions and/or grooves being arranged in columns, and/or at the front face of the printed circuit board comprising arrays of planar metallic structure in form of patches. The scattering surfaces can be implemented in the antenna layer in the form of an array of cavities next to the waveguide channels in order to reduce the reflections between the front face and the back face of the antenna layer, respectively an additional component arranged in front of the antenna device, e.g. a bumper of an automotive etc. The protrusions and/or grooves of a first column are typically displaced with respect to protrusions and/or grooves of a neighboring column by a length essentially equal to the wavelength. Alternatively, the antenna layer can be made as an integral component of a body part, like a bumper, wind shield, headlights etc. Good results can be achieved when the antenna layer, being the front layer of the antenna device is integrally made with the body part, b e.g. injection molding. This has the advantage that the printed circuit board and back part/housing of the antenna device can be mounted more easily, requiring less parts.

Typically, a PCB is composed several inner layers (multilayer PCBs), where at least two of them are of a conductive material. The top layer of the PCB constitutes a metallic material, and it is there where together with the antenna layer a waveguide channels is formed.

The antenna layer can be attached to first metallic layer of the PCB. Alternatively, the antenna layer can be attached to a different conductive layer from a multilayer PCB, without the need of been mechanically connected to the top metallic layer.

Alternatively, the antenna layer can be connected to the housing and all the rest of the parts described here.

To seal the PCB and electronic component from environmental influences, the back face of the antenna layer can be welded to the housing. Alternatively, or in addition to welding, the antenna layer can also be attached to the housing by gluing or soldering. The back face of the antenna layer is typically welded to a wall of the housing in a circumferential manner. Alternatively, or in addition, the antenna layer may comprise pins, which protrude from the back face of the antenna layer and in the mounted state engage with recesses in the PCB. The pins can be configured to align the antenna layer with respect to the PCB. The PCB can in the mounted state be clamped between the antenna layer and the housing.

Alternatively, or in addition, the antenna layer may comprise pins, which comprise a collar which in the mounted state forms an undercut with the printed circuit board to secure the PCB with respect to the antenna layer. The collar can be formed by plastically or thermoforming of the pins. The PCB may be kept in place by clamping the PCB to the antenna layer by the collars and thereby keeping it in position with respect to the housing. Alternatively, the antenna layer may comprise pins, which comprise a thread. In the mounted state, the antenna layer can be secured in position with respect to the housing by nuts, which are screwed to the pins from the back face of the housing.

Alternatively, the antenna layer may comprise pins, which comprise snap fingers. In the mounted state, the antenna layer may be secured in position with respect to the housing by the snap fingers, engaging with the recess in the back face of the housing. Alternatively in addition to pins with a collar or pins with a thread, the antenna layer may be secured in position with respect to the housing by rivets. By the rivets the PCB can be clamped between antenna layer and housing. Alternatively, the pins for aligning the PCB with respect to the antenna layer can be designed as press fit pins which in the mounted state engage with the PCB. Alternatively, to a screwed solution or to pins, the antenna layer can be mounted to the housing by a bayonet lock. The male pins of the bayonet lock may be arranged at the antenna layer and in the mounted state align with slots in the housing by pushing the antenna layer and the housing together.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings, which should not be considered limiting to the disclosure described in the appended claims.

FIG. 1 shows a first variation of the antenna device in a perspective exploded view from the back and above;

FIG. 2 shows an enlarged detail view of the antenna layer of the antenna device according to FIG. 1;

FIG. 3 shows a perspective exploded view from the front and above of the antenna device according to FIG. 1;

FIG. 4a shows a front view of the antenna device according to FIG. 1;

FIG. 4b shows a sectional view of the antenna device according to FIG. 1;

FIG. 5 shows a second variation of the antenna device in a perspective lateral view with the antenna layer being unfolded;

FIG. 6 shows a third variation of the antenna device in a perspective lateral view with the antenna layer being unfolded;

FIG. 7 shows a fourth variation of the antenna device in a perspective lateral view with the antenna layer being unfolded;

FIG. 8 shows a fifth variation of the antenna device in a perspective lateral view with the antenna layer being unfolded;

FIG. 9 shows a sixth variation of the antenna device in a perspective lateral view with the antenna layer being unfolded;

FIG. 10 shows a seventh variation of the antenna device in a perspective lateral view with the antenna layer being unfolded;

FIG. 11 shows an eighth variation of the antenna device in a perspective lateral view with the antenna layer being unfolded;

FIG. 12 shows a ninth variation of the antenna device in a perspective lateral view with the antenna layer being unfolded;

FIG. 13 shows a tenth variation of the antenna device in a perspective lateral view with the antenna layer being unfolded;

FIG. 14 shows an eleventh variation of the antenna device in a perspective exploded view from the front and above;

FIG. 15 shows a twelfth variation of the antenna device in a perspective lateral view with the antenna layer being unfolded and exploded;

FIG. 16a shows the twelfth variation of the antenna device in a perspective view from the top;

FIG. 16b shows the twelfth variation of the antenna device in a section view from the top;

FIG. 17 shows a thirteenth variation of the antenna device in a perspective lateral view with the antenna layer being unfolded and exploded;

FIG. 18a shows the thirteenth variation of the antenna device in a perspective view from the top;

FIG. 18b shows the thirteenth variation of the antenna device in a sectional view from the top;

FIG. 19 shows a fourteenth variation of the antenna device in a perspective lateral view with the antenna layer being unfolded and exploded;

FIG. 20a shows the fourteenth variation of the antenna device in a perspective view from the top;

FIG. 20b shows the fourteenth variation of the antenna device in a sectional view from the top;

FIG. 21 shows a fifteenth variation of the antenna device in a perspective lateral view with the antenna layer being unfolded and exploded;

FIG. 22a shows the fifteenth variation of the antenna device in a perspective view from the top;

FIG. 22b shows the fifteenth variation of the antenna device in a sectional view from the top;

FIG. 23 shows a line symmetrical periodic pattern of patches forming a AMC structure on the front surface of the PCB;

FIG. 24 shows a glide symmetrical periodic pattern of patches forming a AMC structure on the front surface of the PCB;

FIG. 25 shows a pseudo-periodic or randomized pattern of patches forming a AMC structure on the front surface of the PCB;

FIG. 26 shows a variation of the antenna device with a first variation of the connection element in an unfolded state;

FIG. 27 shows the variation of the antenna device according to FIG. 26 with the hidden edges displayed;

FIG. 28a shows the variation of the antenna device according to FIG. 26 with a sectional view;

FIG. 28b shows the variation of the antenna device according to FIG. 26 with an enlarged view thereof;

FIG. 29 shows a variation of the antenna device with a second variation of the connection element with the hidden edges displayed;

FIG. 30a shows the variation of the antenna device according to FIG. 29 with a sectional view;

FIG. 30b shows the variation of the antenna device according to FIG. 29 with an enlarged view thereof;

FIG. 31 shows a variation of the antenna device with a third variation of the connection element with the hidden edges displayed;

FIG. 32a shows the variation of the antenna device according to FIG. 31 with a sectional view;

FIG. 32b shows the variation of the antenna device according to FIG. 31 with an enlarged view thereof;

FIG. 33 shows a variation of the antenna device with a fourth variation of the connection element with the hidden edges displayed;

FIG. 34a shows the variation of the antenna device according to FIG. 33 with a sectional view;

FIG. 34b shows the variation of the antenna device according to FIG. 33 with an enlarged view thereof;

FIG. 35 shows a variation of the antenna device with a fifth variation of the connection element with the hidden edges displayed;

FIG. 36a shows the variation of the antenna device according to FIG. 35 with a sectional view thereof;

FIG. 36b shows the variation of the antenna device according to FIG. 35 with an enlarged view thereof;

FIG. 37 shows a variation of the antenna device with a sixth variation of the connection element with the hidden edges displayed;

FIG. 38a shows the variation of the antenna device according to FIG. 37 with a sectional view thereof;

FIG. 38b shows the variation of the antenna device according to FIG. 37 with an enlarged view thereof;

FIG. 39 shows a variation of the antenna device with a seventh variation of the connection element with the hidden edges displayed;

FIG. 40a shows the variation of the antenna device according to FIG. 39 with a sectional view thereof;

FIG. 40b shows the variation of the antenna device according to FIG. 39 with an enlarged view thereof;

FIG. 41 shows a variation of the antenna device with an eighth variation of the connection element with the hidden edges displayed;

FIG. 42a shows the variation of the antenna device according to FIG. 41 with a sectional view thereof;

FIG. 42b shows the variation of the antenna device according to FIG. 41 with an enlarged view thereof;

FIG. 43 shows a variation of the antenna device with a ninth variation of the connection element with the hidden edges displayed;

FIG. 44a shows the variation of the antenna device according to FIG. 43 with a sectional view thereof;

FIG. 44b shows the variation of the antenna device according to FIG. 43 with an enlarged view thereof;

FIG. 45 shows a variation of the antenna device with an embedded chip (MMIC) with the antenna layer being unfolded;

FIG. 46a shows the variation of the antenna device according to FIG. 45 as sectional view thereof;

FIG. 46b shows the variation of the antenna device according to FIG. 45 in an enlarged view thereof;

FIG. 47 shows a variation of the antenna device with an embedded chip (MMIC) and PCB waveguide with the antenna layer being unfolded;

FIG. 48a shows the variation of the antenna device according to FIG. 47 as sectional view thereof; and

FIG. 48b shows the variation of the antenna device according to FIG. 47 in an enlarged view thereof.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible like reference numbers will be used to refer to like components or parts.

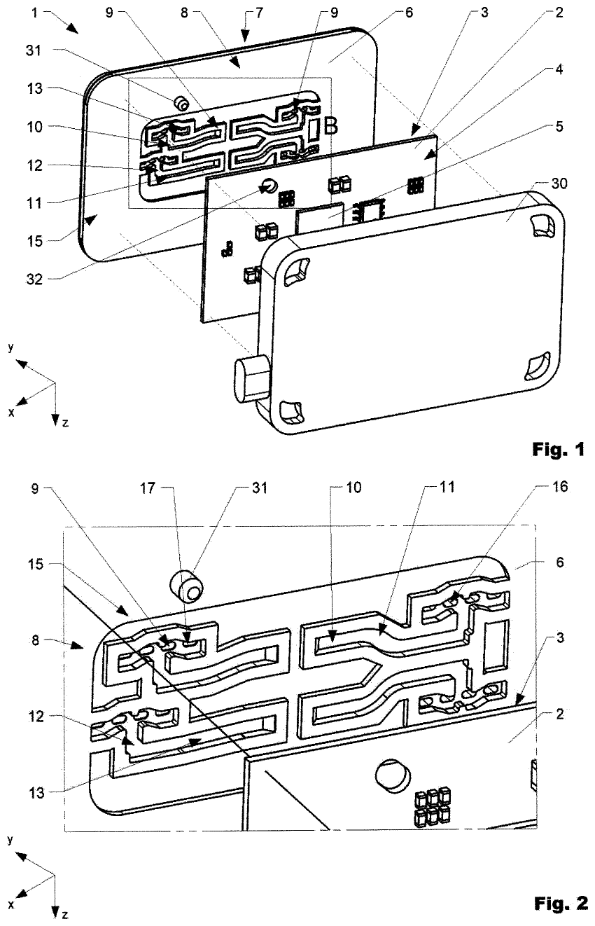

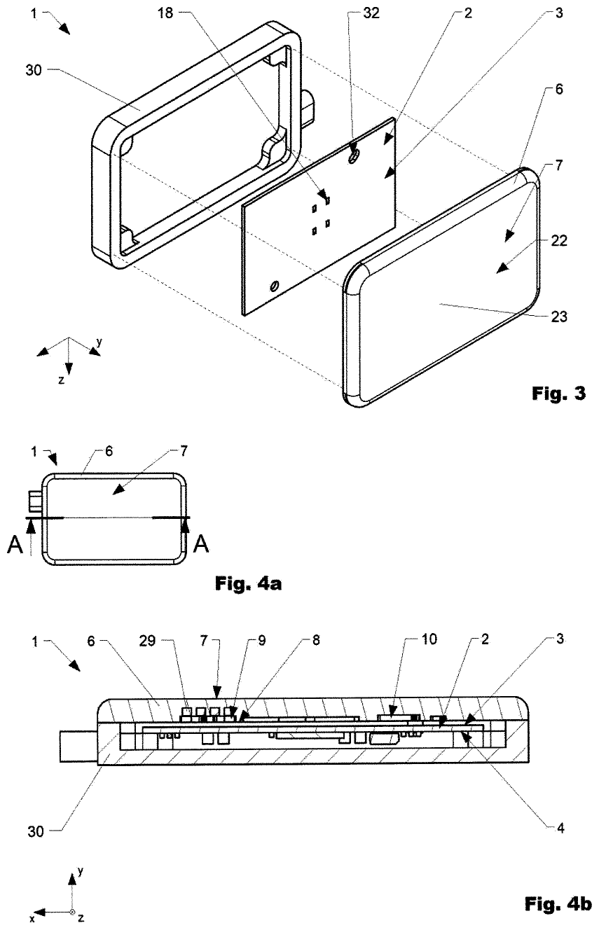

FIGS. 1 to 4 show a first variation of the antenna device 1. FIG. 1 shows the first variation in a perspective exploded view from the back and above. FIG. 2 shows an enlarged detail view of the antenna layer 6 of the first variation of the antenna device 1. FIG. 3 shows a perspective exploded view from the front and above. FIG. 4a shows a front view of the antenna device, FIG. 4b shows a sectional view. The shown antenna device 1 for automotive radar applications comprises a printed circuit board (PCB) 2 having a front face 3 and a back face 4 and an electronic component 5, which is interconnected to the printed circuit board 2. An electronic component 5 in form of a monolithic microwave integrated circuit (MMICs) is used in the shown variation, which comprises multiple circuits integrated into small packages for operation at microwave frequencies. In the shown variation, the MMIC is directly arranged on the front face 3 of the printed circuit board 2. For guiding the signals from the electronic component 5 to at least one waveguide aperture 9, configured for transmitting and/or receiving the signal, the antenna device 1 comprises an antenna layer 6 having a front face 7 and a back face 8, which back face 8 is interconnected to the front face 3 of the printed circuit board 2. In the shown variation, the antenna layer 6 is in addition configured to function as radome, protecting the antenna device 1 from environmental influences. Therefore, the antenna layer 6 is typically made from a material, which is resistant to environmental influences, e.g. one that does not absorb humidity. The shown antenna layer 6 can be at least partially made from a metallic material and/or comprise a metallization layer forming a conductive surface. In case that the antenna layer 6 is made by injection molding of at least one plastic material, typically the back face 8 and/or the recess 12 is metalized by an electrically conductive material.

As can be obtained best from FIGS. 2 and 3, for receiving or transmitting a signal, the shown waveguide apertures 9 are interconnected to the front face 7 of the antenna layer 6 and are communicatively connected to the electronic component by at least one waveguide channel 10. In a variation the at least one waveguide channel 10 is designed as an essentially rectangular waveguide channel 10, which can be seen as a pipe consisting of typically four walls. The shown waveguide channel 10 is formed by a recess 12 arranged between the back face 8 of the antenna layer 6 and the front face 3 of the printed circuit board 2. For being able to guide an electromagnetic signal, the at least one waveguide channel 10 typically comprises a conductive surface 11 for guiding the electromagnetic field between the electronic component and the at least one waveguide aperture 9. The shown waveguide channel 10 is formed by placing the edges of the recess 12 in direct contact with the metallized front face 3 of the PCB 2 or a conductive intermediate layer between the back face 8 of the antenna layer 6 and the front face 3 of the PCB 2. The shown waveguide apertures 9 are incorporated behind the front face 7 of the antenna layer 6 as penetrations 17 in the conductive surface 11. Good results regarding the manufacturability can be achieved when the recess 12, as shown in the present variation, is at least partially formed by a deepening 13 in the back face 8 of the antenna layer 6. This is particularly beneficial for injection molding or die-casting as the parts can be easily demolded.

FIG. 4 shows a variation, which has an antenna layer 6 wherein the waveguide channels 10 extend within the antenna layer 6. The shown waveguide apertures 9 are incorporated as cavities 16 in the back face 8 of the antenna layer 6. The shown cavities in the back face 8 of the antenna layer 6 may at least partially filled by a material that is permeable for the electromagnetic field, for protecting at least the waveguide channel 10 and interior of the antenna device 1 from the environment. The cavities 16 can be filled by dielectric resonators 29, which constitute of a cube made of a material with higher dielectric constant than the surrounding antenna layer 6 (e.g. radome material dk=2, dielectric resonator dk=5.5).

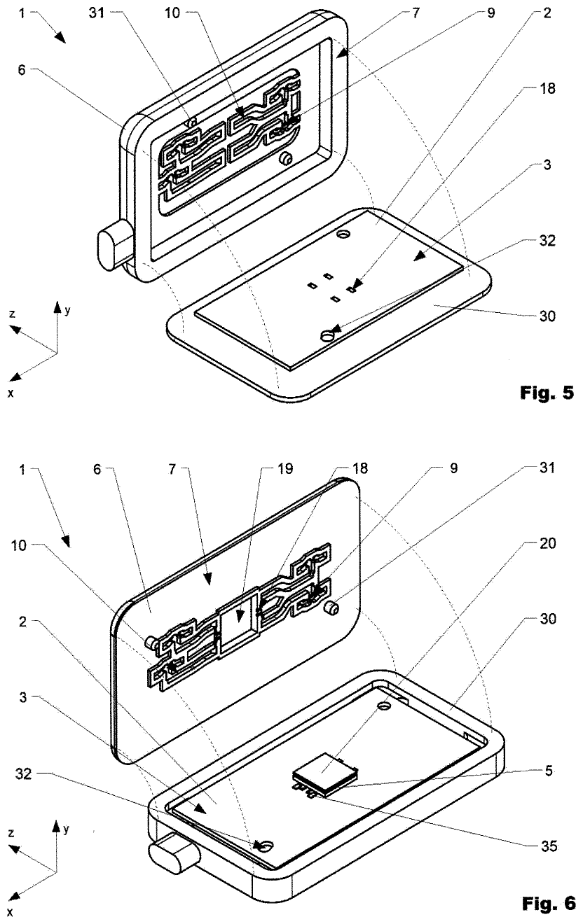

FIG. 5 shows a second variation of the antenna device 1 in a perspective lateral view with the antenna layer 6 being unfolded. The not shown electronic component is arranged at the back face of the printed circuit board 2, communicatively connected to the at least one waveguide channel 10 by a feeding aperture 18 extending across the printed circuit board 2 from the back face to the front face 3. The not shown electronic component in form of a MMIC component is coupled to the waveguide channel 10 through the shown feeding apertures 18 designed as bores through the PCB 2. These bores are typically permeable for electromagnetic waves and can be plated and filled with material or not.

FIG. 6 shows a third variation of the antenna device 1 in a perspective lateral view with the antenna layer 6 being unfolded. The shown electronic component 5 is arranged at the front face 3 of the printed circuit board 2 being in the assembled state encompassed by a receiving space 19 within the antenna layer 6 and covered by an electromagnetic absorber in form of a layer 20. The shown feeding apertures 18 are arranged in the back face 8 of the antenna layer 6 and merge laterally from the receiving space 19 into several waveguide channels 10. The signal is fed from the electronic component 5 into the waveguide channel 10 via planar transition lines 35. The shown electromagnetic absorber 20 in form of a layer is placed on the electronic component 5 to reduce any electromagnetic interference from the waveguide channels 10.

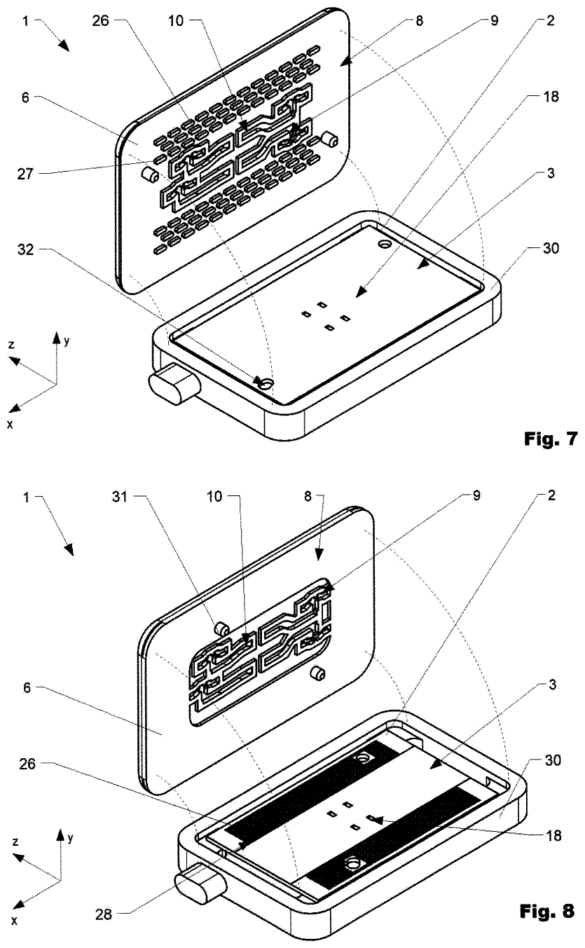

FIG. 7 shows a fourth variation of the antenna device 1 in a perspective lateral view with the antenna layer 6 being unfolded. The shown variation comprises a scattering surface 26 arranged at the back face 8 of the antenna layer 6 adjacent to the at least one waveguide channel 10 consisting of protrusions 27 and/or intrusions in form of grooves being arranged in columns. The shown scattering surface 26 is implemented in the antenna layer 6 in the form of an array of protrusions 27 next to the waveguide channels 10 in order to reduce the reflections between the front face 7 and the back face 8 of the antenna layer 6, respectively an additional component arranged in front of the antenna device 1, e.g. a bumper of an automotive etc. The protrusions 27 and/or grooves (not shown) of a first column are typically displaced with respect to protrusions 27 and/or grooves of a neighboring column by a length essentially equal to the wavelength. FIG. 8 shows a fifth variation of the antenna device 1 in a perspective lateral view with the antenna layer 6 being unfolded. In the shown variation, the scattering surface 26 is implemented on the front side 3 of the PCB 2 in the form of an array of metallic planar patches 28 e.g. square patches next to the feeding apertures 18.

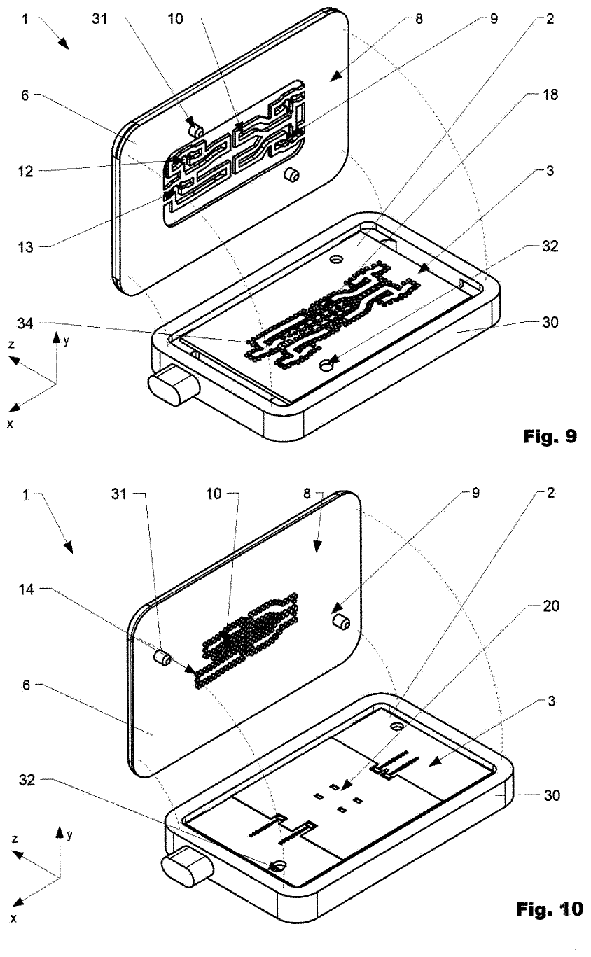

FIGS. 9 to 13 show the sixth through the tenth variations with a waveguide channel 10 being partially formed by an electromagnetic band-gap structure (EBG). The recess 12 of the shown variations is formed by protrusions 14, forming the electromagnetic band-gap structure (EBG), which extends above the back face 8 of the antenna layer 6 and/or the front face 3 of the printed circuit board 2. The shown protrusions 14 form the recess 12 by laterally delimiting the waveguide channel 10. The protrusions 14 can be made integrally with the antenna layer 6 or are arranged at the font face 3 of the printed circuit board 2 in form of a number of metallized patches 28 arranged on the front face 3 of the PCB 2.

FIG. 9 shows a sixth variation of the antenna device 1 in a perspective lateral view with the antenna layer 6 being unfolded. In the shown variation, the waveguide channels 10 are designed as a deepening 13 arranged in the back face 8 of the antenna layer 6 and patches 34 arranged on the front face 3 of the PCB 2 encompassing the recess 12. The patches 34 on the front face 3 of the shown PCB 2 are a metasurface to avoid leakage. FIG. 10 shows a seventh variation of the antenna device 1 in a perspective lateral view with the antenna layer 6 being unfolded. The signal is fed from the MMIC electronic component (not shown) into the waveguide channels 10, which in turn feed planar antennas e.g. patch antenna or as shown SIW slot antennas integrated on the front face 3 of the PCB 2. FIG. 11 shows an eighth variation of the antenna device 1 in a perspective lateral view with the antenna layer 6 being unfolded with a waveguide channel 10 formed by protrusions 14.

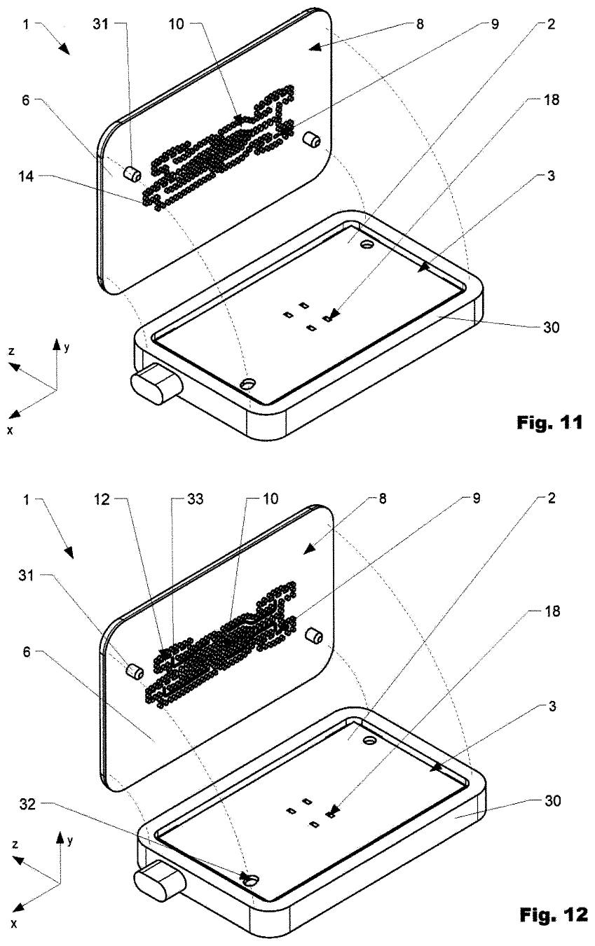

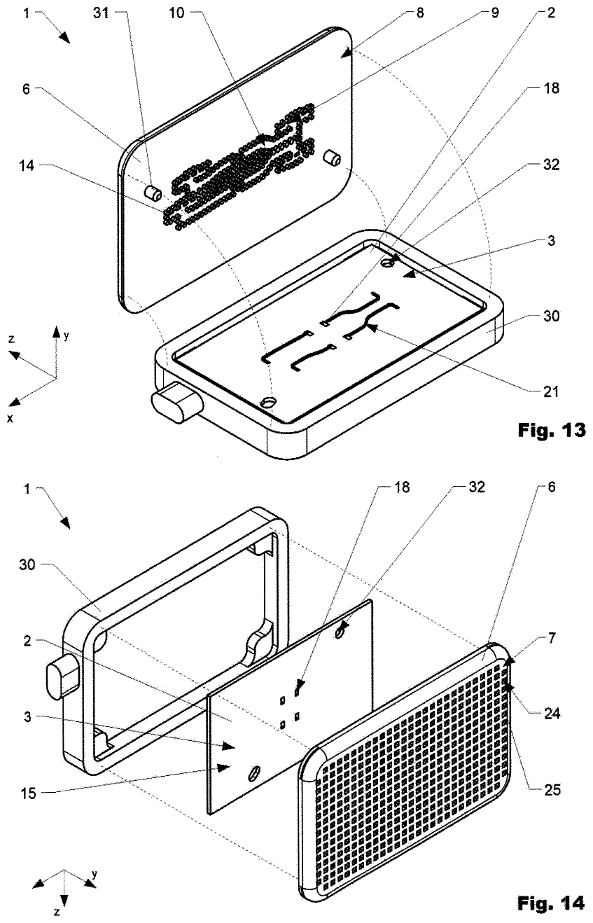

FIG. 12 shows a ninth variation of the antenna device 1 in a perspective lateral view with the antenna layer 6 being unfolded. The antenna layer may comprise a ridge 33, which is arranged within the recess 12 and extends substantially along the waveguide channel 10. The ridge 33 can essentially extend from the feeding aperture 18 to the at least one waveguide aperture 9. The ridge 33 can be arranged within the recess 12 of the waveguide channel 10 for reducing the overall size of the waveguide channel 10. FIG. 13 shows a tenth variation of the antenna device 1 in a perspective lateral view with the antenna layer 6 being unfolded. The shown waveguide channels 10 comprise a coaxial waveguide by including a metallic strip at the center of the waveguide channel, which functions as an inner conductor 21. The inner conductor 21 enables a further size reduction of the waveguide channel 10.

FIG. 14 shows an eleventh variation of the antenna device 1 in a perspective exploded view from the front and above with a corrugated front face. The front face 7 of the shown antenna layer 6 is corrugated 24 to further reduce the permittivity and implement a quarter-wavelength impedance transformation for the wave radiated from the waveguide apertures through the front surface 7. The corrugation 24 allows removing material from the antenna layer 6, which can be replaced by air, thus reducing the overall permittivity of the antenna device 1. The waves radiated from the waveguide apertures 9 propagate in a material with lower permittivity. As such, they undergo less distortion and the structure may achieve a more uniform radiation profile. The front face 7 of the shown antenna layer 6 is designed as a corrugated surface 24 comprising arrays of indentations 25 for reducing the overall permittivity.

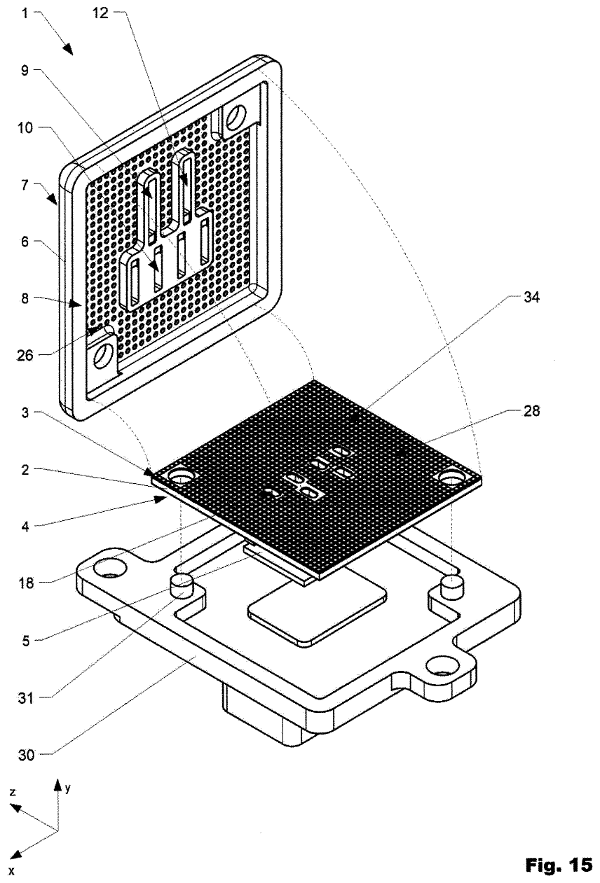

FIGS. 15 and 16 show a twelfth variation of the antenna device 1. The shown antenna device 1 comprises a printed circuit board (PCB) 2 having a front face 3 and a back face 4 and an electronic component 5, which is arranged on the back face 4 of the PCB 2. The waveguide apertures 9 are interconnected to the front face 7 of the antenna layer 6 and communicatively connected to the electronic component 5 by waveguide channels 10. The shown waveguide channels 10 are formed by a recess 12, being partially arranged in the back face 8 of the antenna layer 6 and the front face 3 of the PCB 2. A number of metallic patches 34 are arranged on the front face 3 of the PCB 2 forming an AMC structure. The metallic patches 34 are arranged on the front face 3 of the PCB 2 in a symmetrical pattern with a periodic spacing. This design makes use of the underlying concept of a half-mode waveguide, to halve the height of the waveguide channel. To be able to halve the height the E-field of the signal is mirrored by planar metallic structure 28. The electromagnetic field is fed into the waveguide channels 10 via feeding apertures 18 arranged within the PCB 2. In addition, the antenna layer 6 comprises a scattering surface 26, arranged at the back face 8 of the antenna layer 6, adjacent to the waveguide channels 10. The shown scattering surface 26 is implemented in the back face 8 of the antenna layer 6 in form of arrays of cavities next to the waveguide channels 10 in order to reduce the reflections between the front face 7 of the antenna layer 6 and the back face 8 of the antenna layer 6, respectively an additional component arranged in front of the antenna device 1, e.g. a bumper of an automotive etc. The shown antenna layer 6 is configured to function as a radome that protects at least the front face 3 of the printed circuit board 2 from environmental influences.

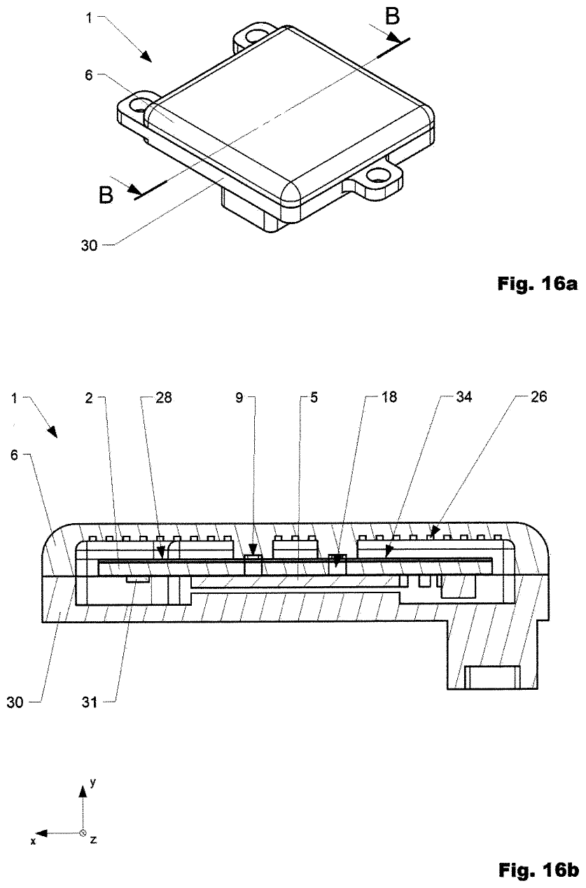

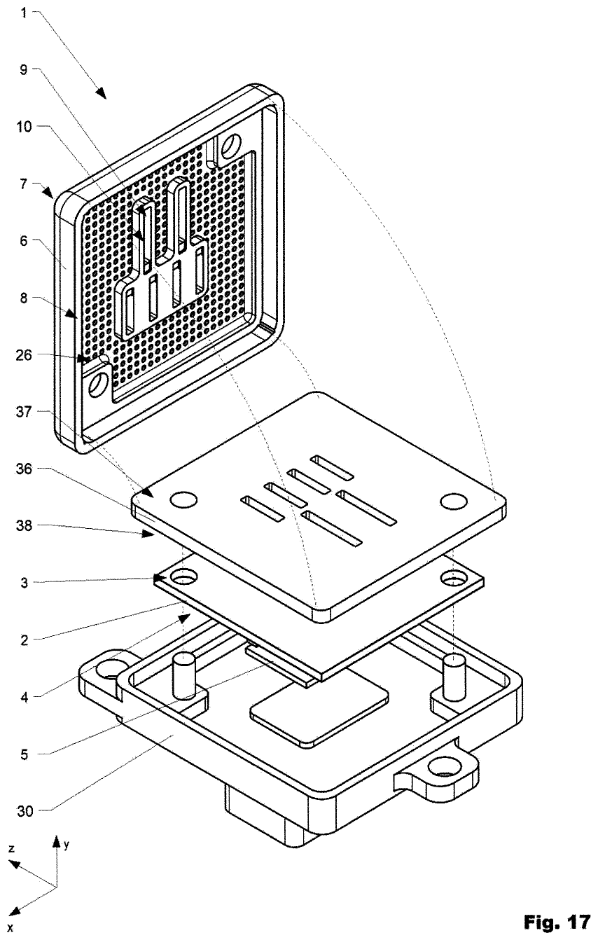

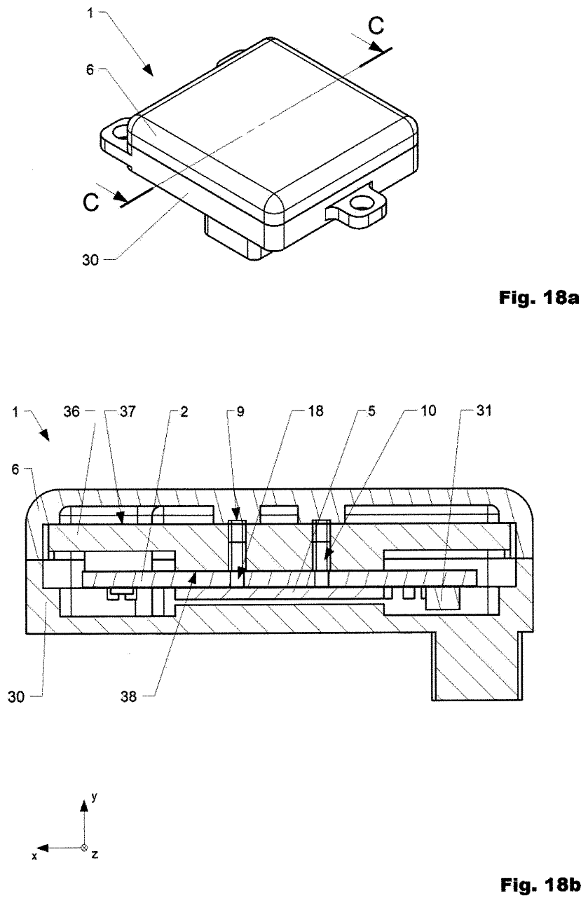

FIGS. 17 and 18 show a thirteenth variation of the antenna device 1. The shown antenna device 1 comprises a printed circuit board (PCB) 2 having a front face 3 and a back face 4 and an electronic component 5, which is arranged on the back face 4 of the PCB 2. Between the front face 4 of the PCB 2 and the back face 8 of the antenna layer 6, an intermediate layer 36 is arranged. A front face 37 of the intermediate layer 36 faces the back face 8 of the antenna layer 6. A back face 38 of the intermediate layer 36 faces the front face 3 of the PCB 2. The waveguide apertures 9 are interconnected to the front face 7 of the antenna layer 6 and communicatively connected to the electronic component 5 by waveguide channels 10, which are arranged within the intermediate layer 36, extending from the back face 38 to the front face 37. The waveguide channels 10 comprise a conductive surface 11 for guiding the electromagnetic field between the electronic component 5 and the waveguide apertures 9. The electromagnetic field is fed into the waveguide channels 10 via feeding apertures arranged within the PCB 2. The shown antenna layer 6 comprises a scattering surface 26, implemented in the back face 8 in form of arrays of cavities next to the waveguide channels 10, in order to reduce the reflections between the front face 7 and the back face 8 of the antenna layer 6 or an additional component.

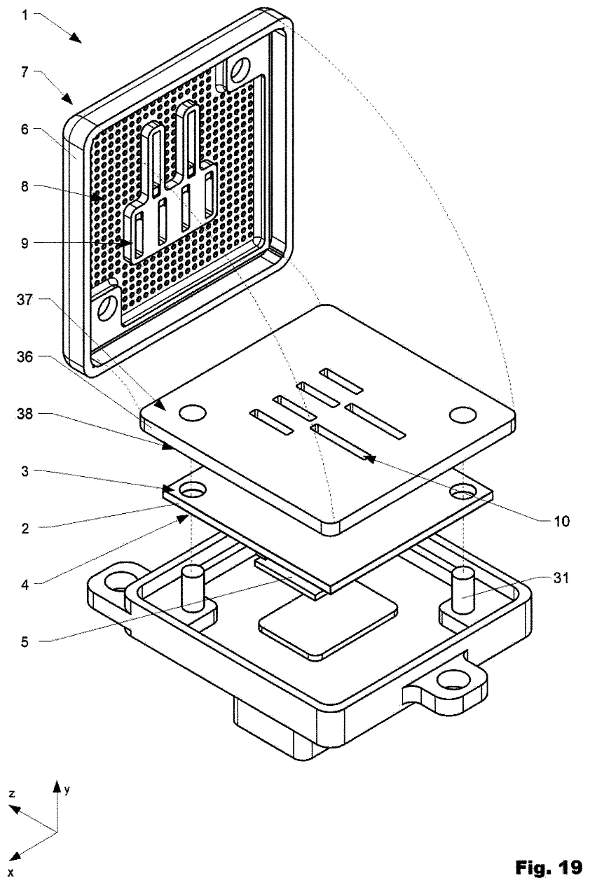

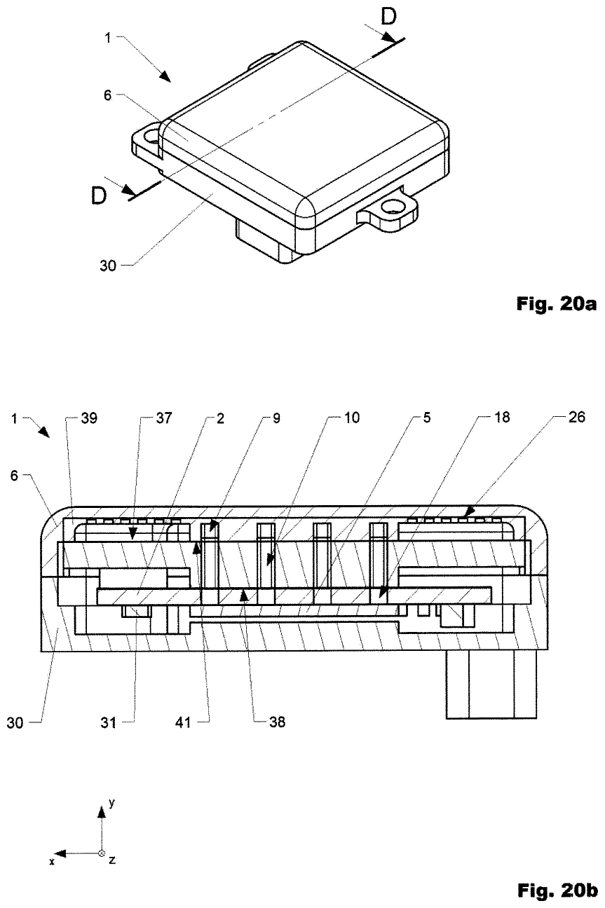

FIGS. 19 and 20 show a fourteenth variation of the antenna device 1. The shown antenna device 1 comprises a printed circuit board (PCB) 2 having a front face 3 and a back face 4 and an electronic component 5, which is arranged on the back face 4 of the PCB 2. Between the front face 3 of the PCB 2 and the back face 8 of the antenna layer 6, an intermediate layer 36 is arranged. The front face 37 of the intermediate layer 36 facing the back face 8 of the antenna layer 6. The antenna layer 6 of the shown variation is made by insertion molding. A metallic insert 39 is loaded into the mold, and then over molded by a molten plastic which is injected into the mold, forming the antenna layer 6. In the shown variation, the scattering surface 26 is implemented in the back face of the metallic insert 39 of the antenna layer 6, in form of arrays of cavities next to the waveguide channels 10, in order to reduce the reflections between the back face 8 and the front face 7 of the antenna layer 6. The back layer 40 and the front layer 39 are joined along a parting plane 41. The waveguide apertures 9 are interconnected to the front face 7 of the antenna layer 6 and communicatively connected to the electronic component 5 by waveguide channels 10, which are arranged within the intermediate layer 36, extending from the back face 38 to the front face 37. The waveguide channels 10 comprise a conductive surface 11 for guiding the electromagnetic field between the electronic component 5 and the waveguide apertures 9.

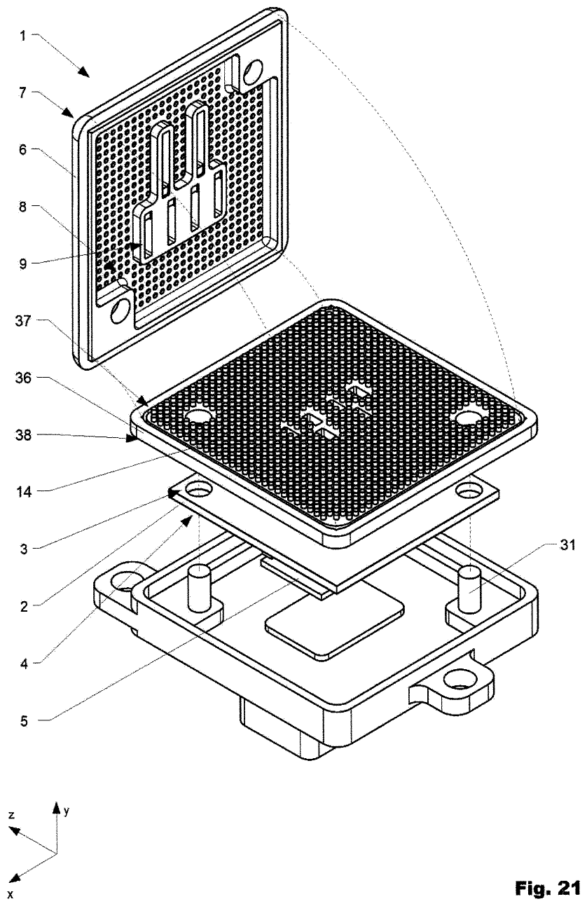

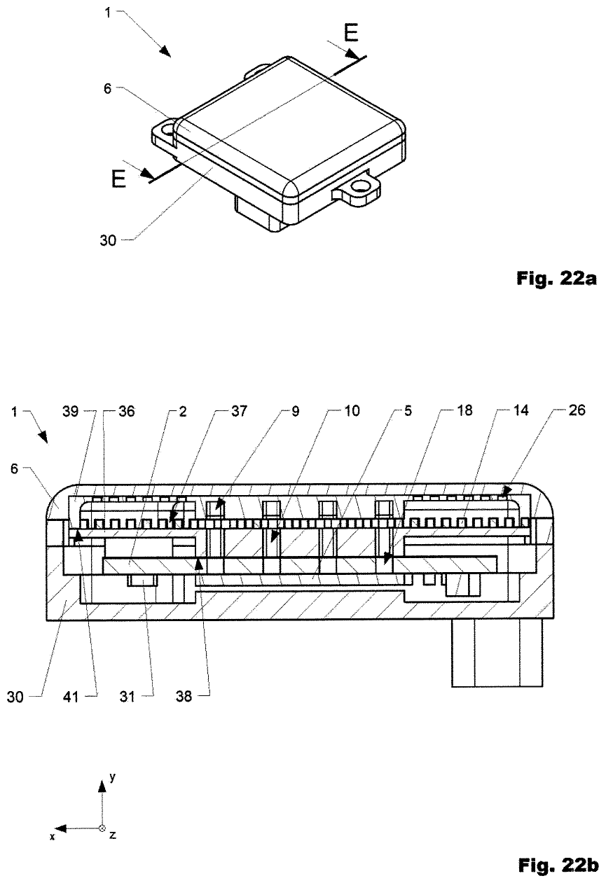

FIGS. 21 and 22 show a fifteenth variation of the antenna device 1. The shown antenna device 1 comprises a printed circuit board (PCB) 2 having a front face 3 and a back face 4 and an electronic component 5, which is arranged on the back face 4 of the PCB 2. Between the front face 3 of the PCB 2 and the back face 8 of the antenna layer 6, an intermediate layer 36 is arranged. In the shown variation, the intermediate layer 36 comprises protrusions 14 arranged on the front face 37 of the intermediate layer. The antenna layer 6 of the shown variation is made by insertion molding. A metallic insert 39 is loaded into the mold, and then overmolded by a molten plastic which is injected into the mold, forming the antenna layer 6. In the shown variation, the scattering surface 26 is implemented in the back face of the metallic insert 39 of the antenna layer 6, in form of arrays of cavities next to the waveguide channels 10, in order to reduce or cancel out the reflections between the back face 8 and the front face 7 of the antenna layer 6. The waveguide apertures 9 are interconnected to the front face 7 of the antenna layer 6 and communicatively connected to the electronic component 5 by waveguide channels 10, which are partially arranged within the intermediate layer 36, extending from the back face 38 to the front face 37. The waveguide channels 10 comprise a conductive surface 11 for guiding the electromagnetic field between the electronic component 5 and the waveguide apertures 9. The electromagnetic field is fed into the waveguide channels 10 via feeding apertures 18 arranged within the PCB 2. This design makes use of the underlying concept of a half-mode waveguide, to halve the height of the waveguide channel.

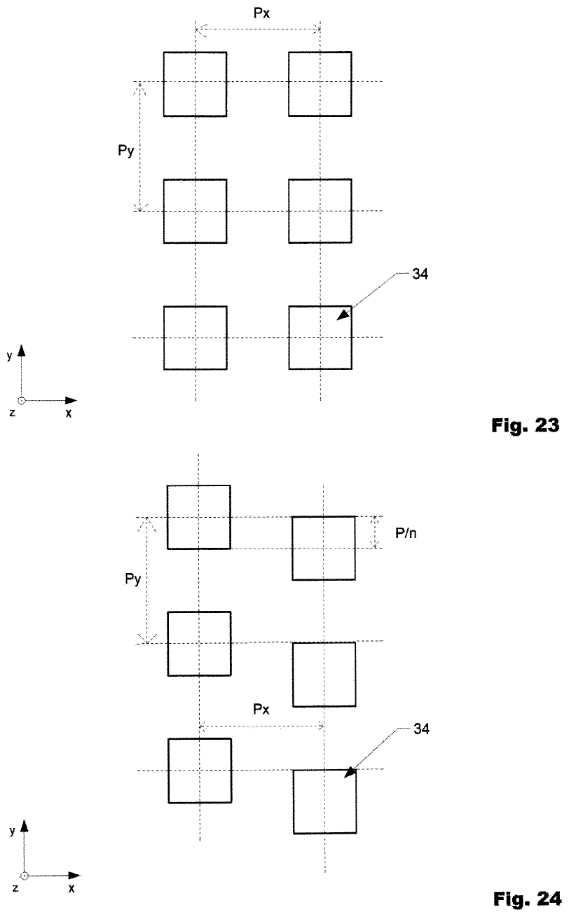

FIG. 23 shows a schematic line symmetrical periodic pattern of metallic patches 34 forming a AMC structure on the front surface of the PCB 2. The essentially squared metallic patches 34 are arranged line symmetrical with respect to each other with a equal spacing in x and y direction. The lateral distance between the patches with respect to each other, the periodicity, is typically chosen in relation to the emitted wavelength. The size of the patches is related to the guided wavelength. The wavelength can be calculated as follows:

$$λ = \frac{{λ}_{0}}{\sqrt{{ε}_{rPCB}}}$$

λ₀=free air wavelength
ε_{r PCB}=permittivity of the PCB substrate

The periodicity is usually chosen in a range between λ₀/8−2λ₀. The patches are typically arranged in collinear arrays, with the arrays forming rows and columns. Between neighboring columns the patches are spaced with a first periodicity Pₓ and between neighboring rows with a second periodicity P_{y}.

FIG. 24 shows a glide symmetrical periodic pattern of metallic patches 34 forming a AMC structure on the front surface of the PCB 2. Compared to the variation shown in FIG. 23, the patches within one array are again spaced with a distance equal to the periodicity. Neighboring arrays are shifted with respect to each other by a distance which equals to P/n with n being natural numbers.

FIG. 25 shows a pseudo-periodic or randomized pattern of patches forming a AMC structure on the front surface of the PCB. The essentially circular metallic patches 34 are arranged asymmetrical with respect to each other with a random spacing in x and y direction. The lateral distance between the patches with respect to each other, the periodicity, is typically chosen as follows:

$${\sum }_{n = 1}^{N} \frac{{d}_{n}}{N} ∼ P$$

N=number of patches
dₙ=distance between patches

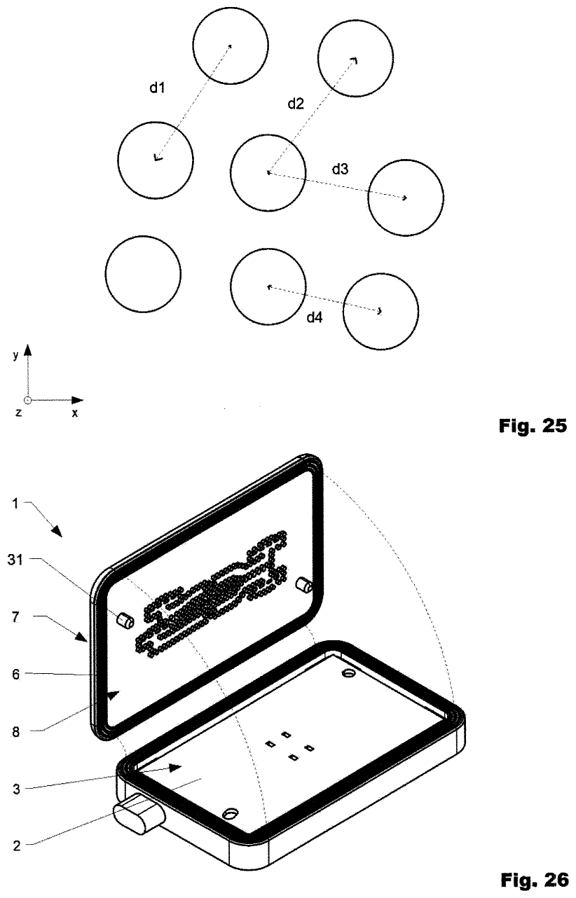

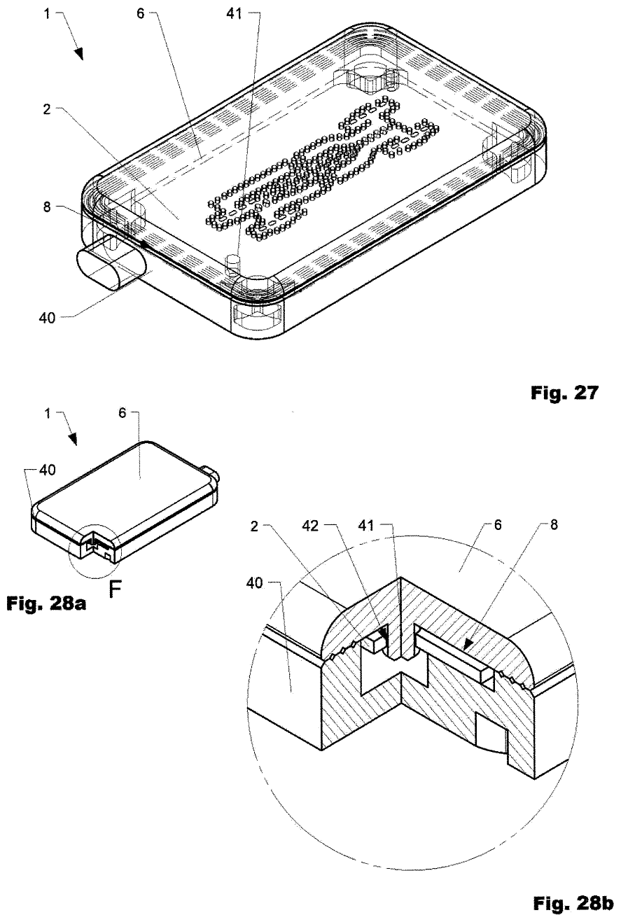

FIGS. 26 to 28 show a variation of the antenna device 1 with a first variation of the connection element 31. The shown antenna device 1 comprises a printed circuit board (PCB) 2 and an electronic component, which is interconnected to the printed circuit board 2. The shown antenna layer 6 has a front face 7 and a back face 8, which back face 8 is interconnected to the front face 3 of the printed circuit board 2. In the shown variation, the antenna layer 6 is in addition configured to function as radome, protecting the antenna device 1 from environmental influences. As can be obtained best from FIG. 27, to seal the PCB 2 and electronic component from environmental influences, the back face 8 of the antenna layer 6 is welded to the housing 40. Alternatively, or in addition to welding, the antenna layer 6 can also be attached to the housing 40 by gluing or soldering. In the shown variation, the back face 8 of the antenna layer 6 is welded to a wall of the housing 40 in a circumferential manner. As can be obtained best from FIG. 28, the antenna layer 6 is in the mounted state attached to the housing 40 via welding. The shown antenna layer 6 comprises pins 41, which protrude from the back face 8 of the antenna layer 6 and in the mounted state engage with recesses 42 in the PCB 2. The shown two pins 41 are configured to align the antenna layer 6 with the PCB 2. The PCB 2 is in the mounted state clamped between the antenna layer 6 and the housing 40.

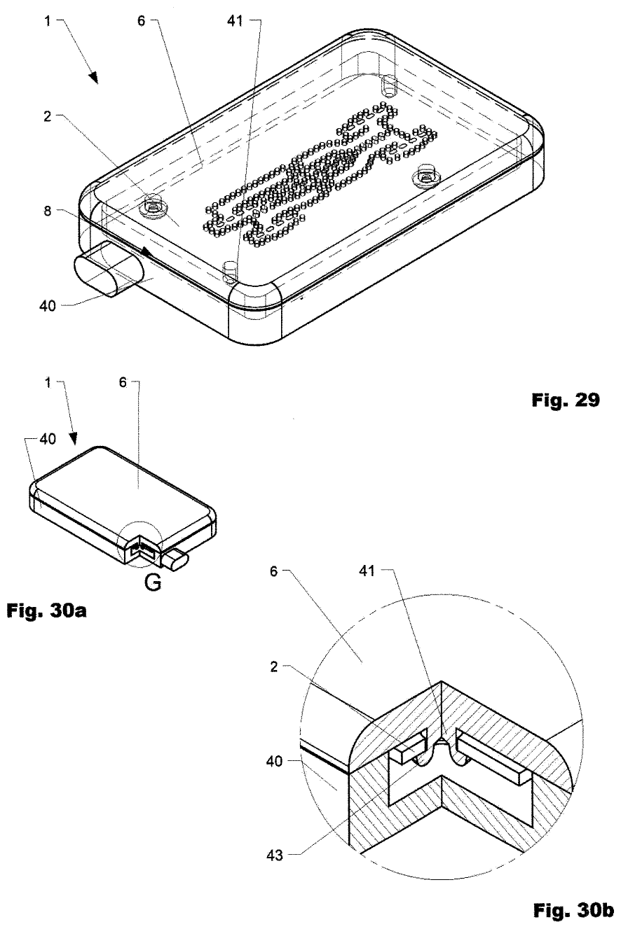

FIGS. 29 and 30 show a variation of the antenna device 1 with a second variation of the connection element 31. The shown antenna device 1 comprises the same components as the variation shown in FIGS. 26 to 28. As can be obtained best from FIG. 29, the shown antenna layer 6 is in the mounted state also attached to the housing 40 via welding, in the shown variation via ultrasonic welding. The antenna layer 6 also comprises pins 41, configured to align the antenna layer 6 with the PCB 2. In addition, as can be obtained best from FIG. 30, the antenna layer 6 comprises pins 41, which comprise a collar 43. In the mounted state, the collar 43 forms an undercut with the printed circuit board 2 to secure the PCB 2 with respect to the antenna layer 6. The collar 43 is formed by plastically or thermoforming of the pins 41. The PCB 2 is kept in place by clamping the PCB 2 to the antenna layer 6 by the collars 43 and thereby keeping it in position with respect to the housing 40.

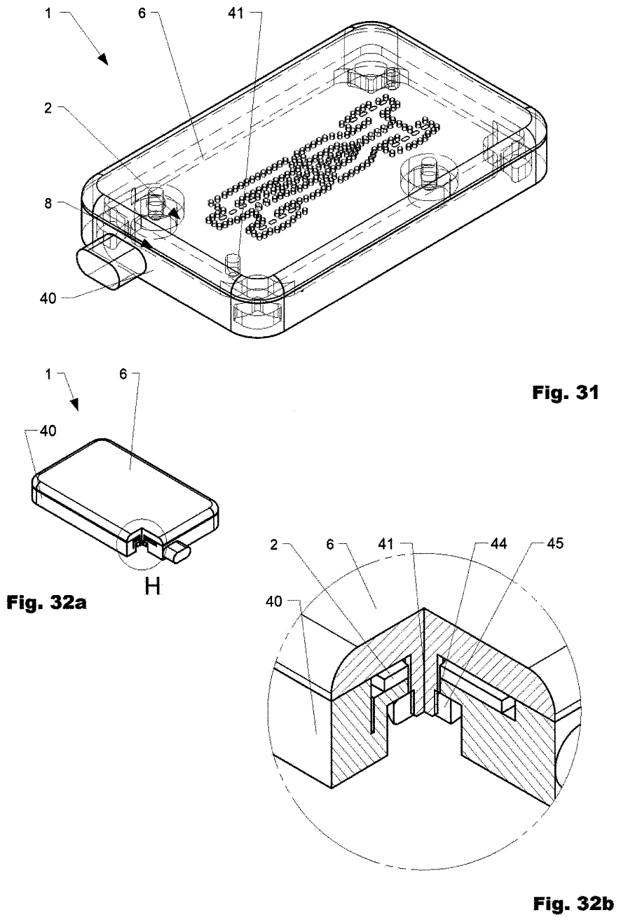

FIGS. 31 and 32 show a variation of the antenna device 1 with a third variation of the connection element 31. The shown antenna device 1 comprises the same components as the variation shown in FIGS. 26 to 28. As can be obtained best from FIG. 31, the shown antenna layer 6 is in the mounted state also attached to the housing 40 via a connection element 31, which comprises pins 41, like the pins shown by FIGS. 26 to 28. In addition, as can be obtained best from FIG. 32, the antenna layer 6 comprises pins, which comprise a thread 44. In the mounted state, the antenna layer 6 is secured in position with respect to the housing 40 by nuts 45, which are screwed to the pins 41 from the back face of the housing 40. The PCB 2 is thereby clamped between antenna layer 6 and housing 40.

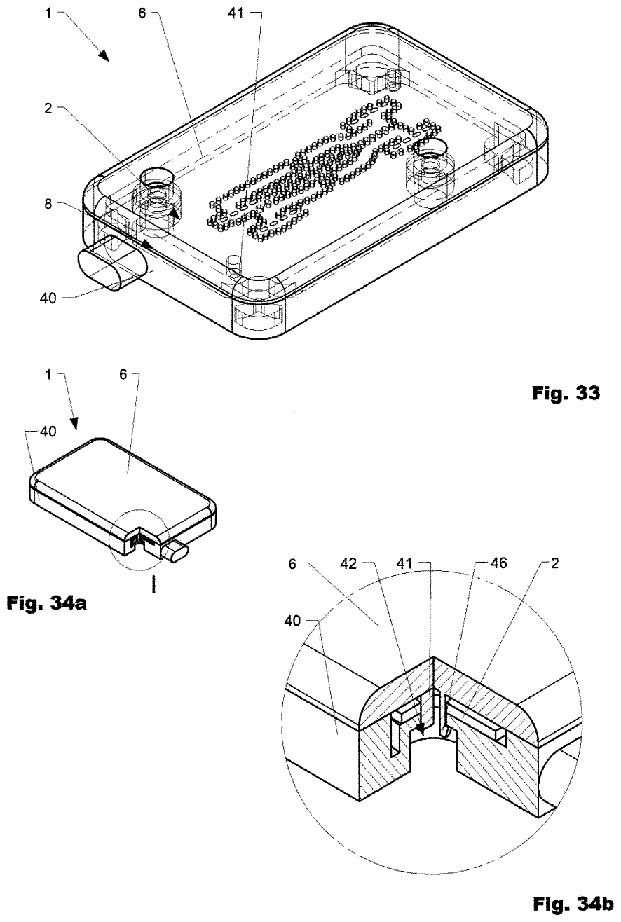

FIGS. 33 and 34 show a variation of the antenna device 1 with a fourth variation of the connection element 31. The shown antenna device 1 comprises the same components as the variation shown in FIGS. 26 to 28. As can be obtained best from FIG. 33, the shown antenna layer 6 is in the mounted state also attached to the housing 40 via a connection element 31, which comprises pins 41, like the pins shown by FIGS. 26 to 28. In addition, as can be obtained best from FIG. 34, the antenna layer 6 comprises pins, which comprise snap fingers 46. In the mounted state, the antenna layer 6 is secured in position with respect to the housing 40 by the snap fingers 46 engaging with the recess 42 in the back face of the housing 40. By the snap joint the PCB 2 is clamped between antenna layer 6 and housing 40.

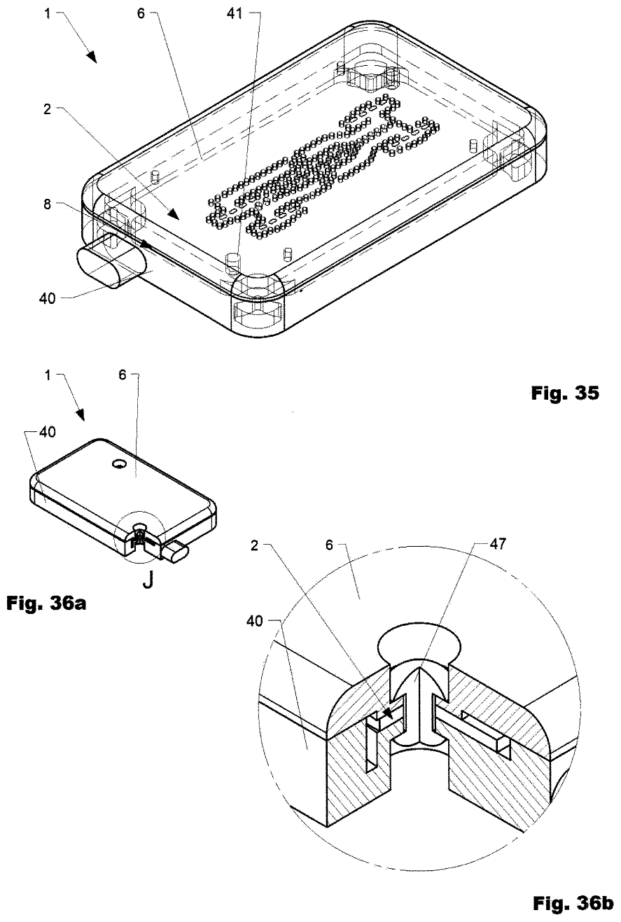

FIGS. 35 and 36 show a variation of the antenna device 1 with a fifth variation of the connection element 31. The shown antenna device 1 comprises the same components as the variation shown in FIGS. 26 to 28. As can be obtained best from FIG. 35, the shown antenna layer 6 is in the mounted state also attached to the housing 40 via a connection element 31, which comprises pins 41, like the pins shown by FIGS. 26 to 28. In addition, as can be obtained best from FIG. 36, the antenna layer 6 is secured in position with respect to the housing 40 by rivets 47. By the rivets 47 the PCB 2 is clamped between antenna layer 6 and housing 40.

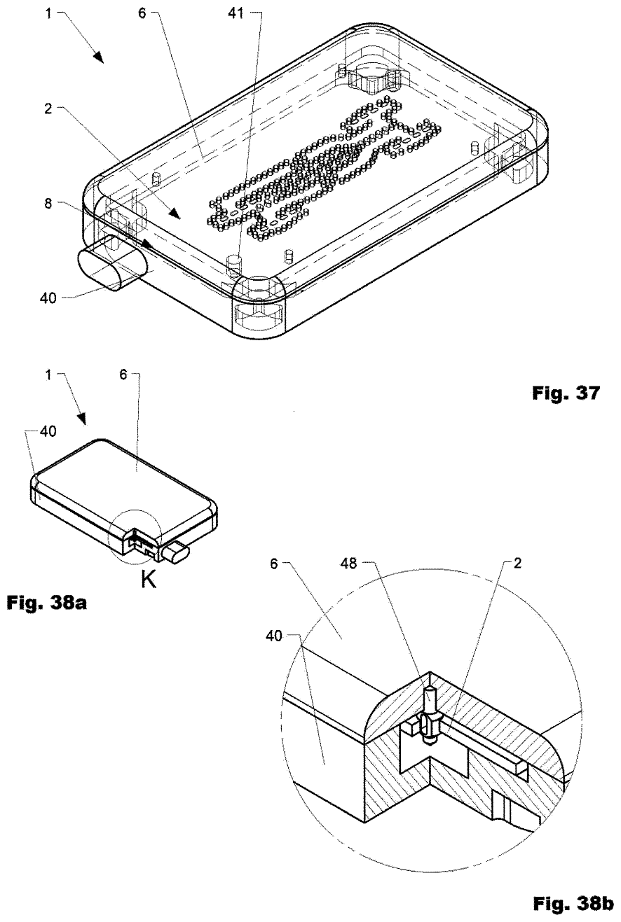

FIGS. 37 and 38 show a variation of the antenna device 1 with a sixth variation of the connection element 31. The shown antenna device 1 comprises the same components as the variation shown in FIGS. 26 to 28. As can be obtained best from FIG. 37, the shown antenna layer 6 is welded, glued or soldered to the housing 40. The antenna layer also comprises press fit pins 48, as can be obtained best from FIG. 38. The antenna layer 6 comprises pins 41 for aligning the PCB 2 with respect to the antenna layer 6 by engaging with the recesses 42 in the PCB 2 and the press fit pins 48 in the mounted state engage with the PCB 2. The PCB 2 is thereby clamped to the antenna layer 6 and the antenna layer 6 is secured with respect to the housing 40.

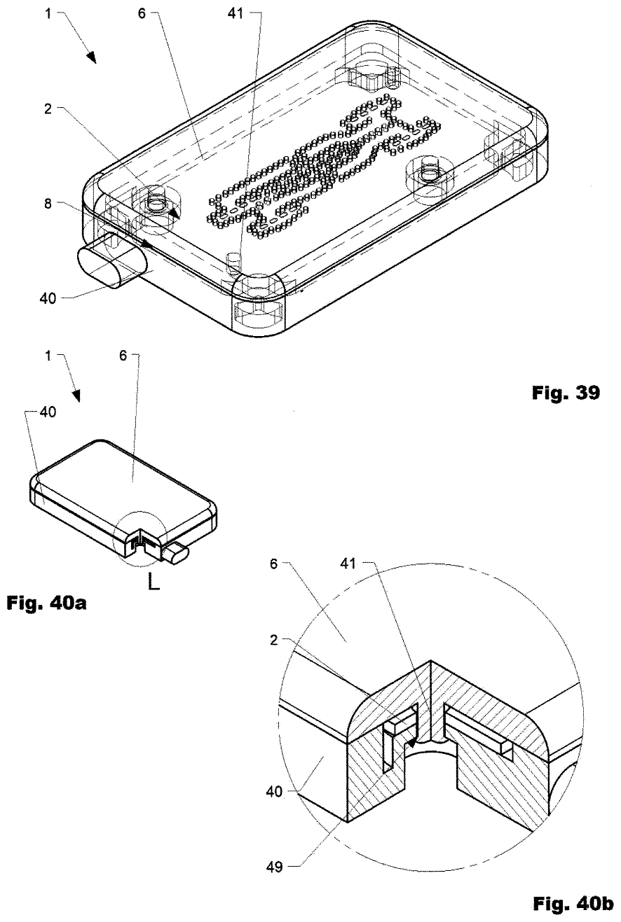

FIGS. 39 and 40 show a variation of the antenna device 1 with a seventh variation of the connection element 31. The shown antenna device 1 comprises the same components as the variation shown in FIGS. 26 to 28. As can be obtained best from FIG. 39, the shown antenna layer 6 is in the mounted state also attached to the housing 40 via a connection element 31, which comprises pins 40, like the pins shown by FIGS. 26 to 28. In addition, as can be obtained best from FIG. 40, the antenna layer 6 comprises pins 41 which in the mounted state engage with bores 49 in the housing 40 and which are hot stamped for securing the antenna layer 6 with respect to the housing 40. The PCB 2 is thereby clamped between antenna layer 6 and housing 40.

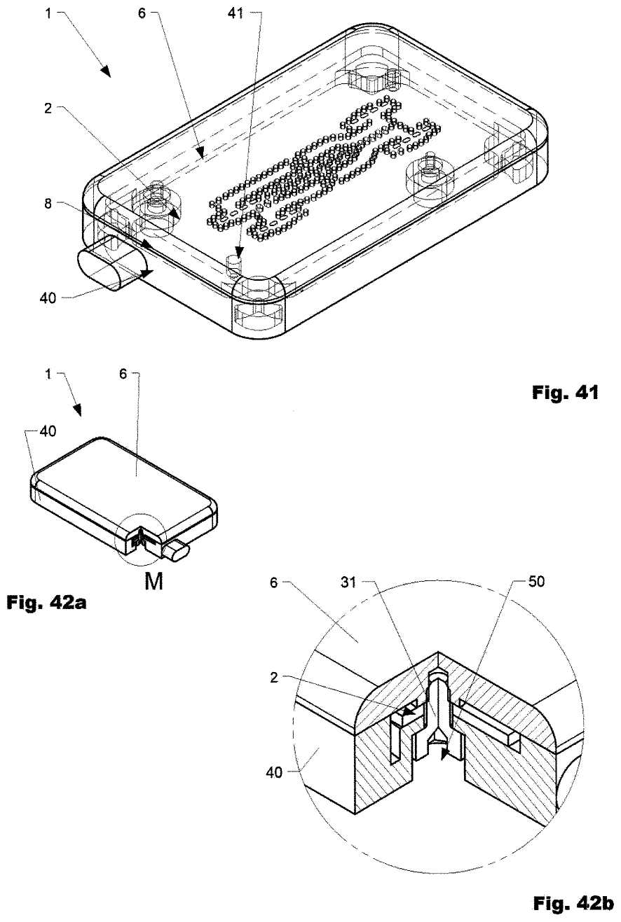

FIGS. 41 and 42 show a variation of the antenna device 1 with an eighth variation of the connection element 31. The shown antenna device 1 comprises the same components as the variation shown in FIGS. 26 to 28. As can be obtained best from FIG. 41, the shown antenna layer 6 is in the mounted state also attached to the housing 40 via a connection element 31, which comprises pins 41, like the pins shown by FIGS. 26 to 28. In addition, as can be obtained best from FIG. 42, the antenna layer 6 is screwed to the housing 40 from the back face of the housing 40. The screws head is thereby in the mounted position arranged in a recess 50 in the back face of the housing 40. The PCB 2 is clamped between antenna layer 6 and housing 40.

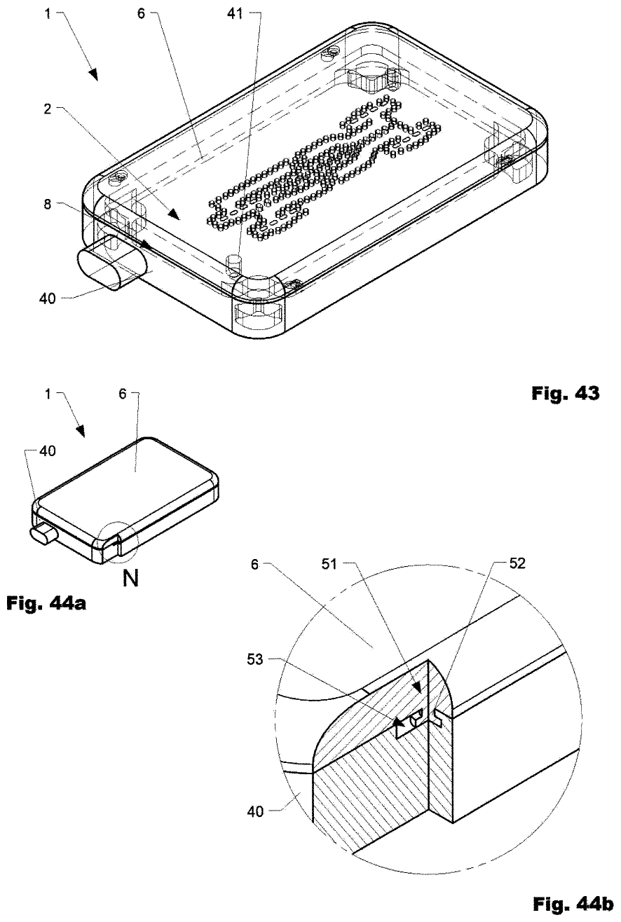

FIGS. 43 and 44 show a variation of the antenna device 1 with a ninth variation of the connection element 31. The shown antenna device 1 comprises the same components as the variation shown in FIGS. 26 to 28. As can be obtained best from FIG. 43, the shown antenna layer 6 is in the mounted state also attached to the housing 40 via a connection element 31, which comprises pins 41, like the pins shown by FIGS. 26 to 28. In addition, as can be obtained best from FIG. 44, the antenna layer 6 is mounted to the housing 40 by a bayonet lock 51. The male pins 52 arranged at the antenna layer are in the mounted state aligned with slots 53 in the housing by pushing the antenna layer and the housing together.

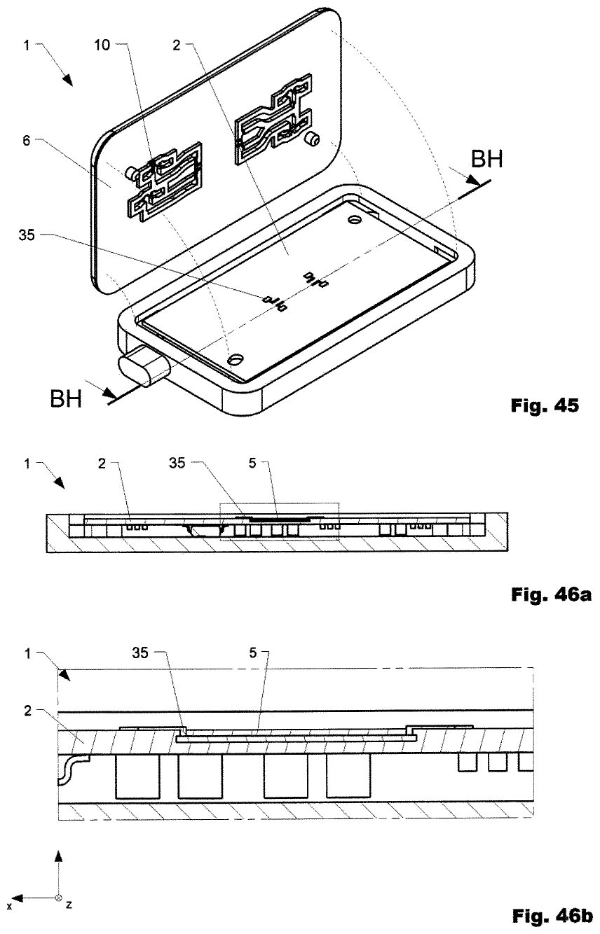

FIGS. 45 and 46 show a variation of the antenna device 1 with an embedded electronic component 5. The shown electronic component 5 is a chip (MMIC), typically a radar chip, which typically comprises multiple circuits integrated into small packages for operation at microwave frequencies. The chip is embedded into the printed circuit board 2. In the shown variation the chip is embedded into one of the layers of the substrate material. Such substrate material typically consists of printed circuit board material or any other material (silicon, ceramic, glass, mold compound) suitable for embedding the chip. The electromagnetic signal is fed from the integrated MMIC to the waveguide channels 10 inside the antenna layer 6 by planar transition lines 35.

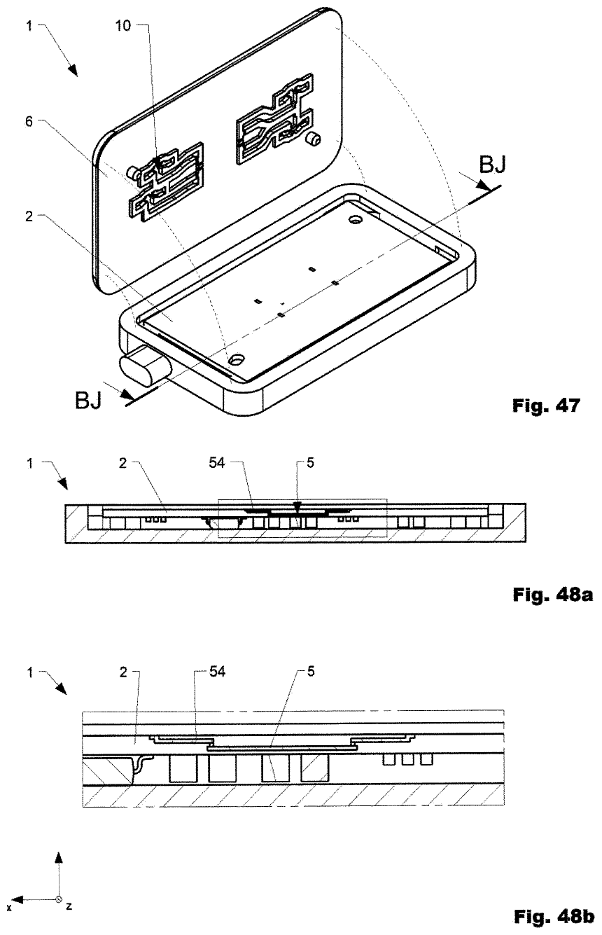

FIGS. 47 and 48 show a variation of the antenna device 1 with an embedded chip (MMIC) and PCB waveguide. Similar to the variation shown by FIGS. 45 and 46, the electronic component 5 is also embedded into one of the layers of the printed circuit board 2 by being embedded in the substrate material. Different to the variation shown by FIGS. 45 and 46, the electromagnetic signal is fed from the electronic component 5 to the waveguide channels 10 inside the antenna layer 6 by three-dimensional transition lines 54. The three-dimensional transition lines 54 are in the form of substrate integrated waveguides (SIW), dielectrically loaded embedded waveguides and/or air-filled embedded waveguides.

Rather, the words used in the specification are words of description rather than limitation, and it is understood that various changes may be made without departing from the Spirit and scope of the disclosure.

1. An antenna device for automotive radar applications comprising
a. a printed circuit board having a front face and a back face and an electronic component which is interconnected to the printed circuit board,
b. an antenna layer having a front face and a back face, which back face is interconnected to the front face of the printed circuit board, wherein
i. at least one waveguide aperture is interconnected to the front face of the antenna layer and is communicatively connected to the electronic component by at least one waveguide channel, wherein
ii. the at least one waveguide channel comprises a conductive surface for guiding an electromagnetic field between the electronic component and is formed by a recess arranged between the back face of the antenna layer and the front face of the printed circuit board.

2. The antenna device according to claim 1, wherein the front face of the antenna layer is configured to function as a radome that protects at least the front face of the printed circuit board from environmental influences.

3. The antenna device according to claim 1, wherein the recess is at least partially formed by at least one of the following: a deepening in the back face of the antenna layer, protrusions extending above the back face of the antenna layer, and a planar metallic structure on the front face of the printed circuit board.

4. The antenna device according to claim 3, wherein the protrusions laterally delimit the recess and form an electromagnetic band-gap structure with the front face of the printed circuit board.

5. The antenna device according to claim 3, wherein the planar metallic structure comprises a number of patches which laterally delimit the recess and form an electromagnetic band-gap structure with the protrusions or the back face of the antenna layer.

6. The antenna device according to claim 1, wherein the front face of the printed circuit board is at least partially covered by a number of metallic patches which are arranged as a periodic structure and form an artificial magnetic conductor.

7. The antenna device according to claim 1, wherein the antenna layer is at least partially made from a metallic material and comprises a metallization layer forming a conductive surface.

8. The antenna device according to claim 1, wherein at least one waveguide aperture is incorporated behind the front face of the antenna layer as a penetration in a conductive surface.

9. The antenna device according to claim 8, wherein the penetration is established by a material ablation process step.

10. The antenna device according to claim 1, wherein at least one waveguide aperture is incorporated as a cavity in the back face of the antenna layer, which cavity is at least partially filled by a material that is permeable for electromagnetic waves.

11. The antenna device according to claim 1, wherein the electronic component is arranged at the back face of the printed circuit board communicatively connected to the at least one waveguide channel by a feeding aperture extending across the printed circuit board from the back face to the front face.

12. The antenna device according to claim 1, wherein the electronic component is arranged at the front face of the printed circuit board being in an assembled state encompassed by a receiving space within the antenna layer.

13. The antenna device according to claim 12, wherein a feeding aperture is arranged in the back face of the antenna layer merging into a waveguide channel which merges into the waveguide aperture arranged at the front face of the antenna layer.

14. The antenna device according to claim 1, wherein the antenna layer comprises a ridge which is arranged within the recess and extends substantially along the waveguide channel.

15. The antenna device according to claim 1, wherein the antenna layer is made by an injection molding process made of a foamed material.

16. The antenna device according to claim 1, wherein the front face of the antenna layer is designed as a corrugated surface comprising arrays of indentations for reducing the overall permittivity.

17. The antenna device according to claim 1, wherein a scattering surface is arranged:
a. at the back face of the antenna layer adjacent to the at least one waveguide channel consisting of protrusions and/or grooves being arranged in columns, and/or
b. at the front face of the printed circuit board comprising arrays of planar metallic structure.

18. The antenna device according to claim 17, wherein the protrusions and/or grooves of a first column are displaced with respect to protrusions and/or grooves of a neighboring column by a length essentially equal to a multiple of half a wavelength.

19. The antenna device according to claim 1, wherein the antenna layer is made as an integral component of a body part.

20. The antenna device according to claim 9, wherein the material ablation process step is one out of the group from the following: a laser process and a cutting process.
